(19) United States
(12) Patent Application Publication
(10) Pub. No.: US 2011/0320358 A1
(43) Pub. Date: Dec. 29, 2011

(54) System and Method for Real-Time and Online Straight-Through Processing and Presentment of Checks

(75) Inventors: Michael K. Harris, The Colony, TX (US); Jonathan C. Gilson, Richardson, TX (US)

(73) Assignee: ARGO Data Resource Corporation, Richardson, TX (US)

(21) Appl. No.: 13/103,306

(22) Filed: May 9, 2011

Related U.S. Application Data
(63) Continuation-in-part of application No. 13/096,875, filed on Apr. 28, 2011.
(60) Provisional application No. 61/358,519, filed on Jun. 25, 2010.

(51) Int. Cl. G06Q 40/00

(52) U.S. Cl. 705/45

(57) ABSTRACT

Methods and systems, including computer programs encoded on a non-transitory medium, are disclosed for real-time and/or online straight-through processing, including the forward presentment and return processes of checks and other electronic payment instruments. In one aspect, an image file and transit item associated with a payment item received at a first financial institution are generated during a customer transaction. The image file and item are transmitted to a second financial institution associated with the payment item during the customer transaction performed at the incoming system. The image file and item are then processed and posted at the second financial institution in real-time, with a posting results notification being returned to the first system. During the customer transaction, the first financial institution performs a posting operation based on the posting results notification, thereby allowing the customer and financial institutions to complete the processing of the associated accounts during the customer transaction.

### CLAIM OF PRIORITY

The present application is a continuation-in-part of and claims priority to U.S. patent application Ser. No. 13/096,875, filed Apr. 28, 2011, which claims priority under 35 U.S.C. §119 to U.S. Provisional Application No. 61/358,519, filed Jun. 25, 2010, the entire disclosure of all of which are hereby incorporated by reference.

### TECHNICAL FIELD

The present disclosure relates to real-time and/or online straight-through processing, including forward presentment and return processes for checks and other electronic payment items.

### BACKGROUND

Currently, the bank of first deposit (BOFD) receives a physical check, an image of a physical check, or any other acceptable check substitute (as well as other types of non-electronic and electronic payment items), from an initial point of deposit including a point-of-sale, automated teller machine (ATM), teller system, merchant capture system, or point-of-purchase, processes the check using any suitable technique, and then communicates the physical check, an image of the check, or the check substitute to the receiving (or payor/endpoint) bank for payment and forwarding to the appropriate account holder (maker). In certain situations the BOFD and the receiving (payor/endpoint) bank may be the same financial institution. In current systems, an image of the received physical check can be used with other information derived from the physical check and manual processing to generate a set of data generally describing the received check or payment item. In current systems, the teller or initial point of deposit performs various functions associated with the received payment item, and subsequently sends the check (or associated image and information) to a middle tier architecture where further processing is performed in order to generate a memo post to the appropriate account(s) within the BOFD's accounting systems.

Concurrently with, and continuing after this initial point of deposit processing, additional back-end processes of each check or payment item image are performed, including codeline verification of the scanned Magnetic Ink Character Recognition (MICR) line from the scanned check or payment item, an image quality analysis, an amount keying (if necessary), and fraud-related detection and suspect review, among others. Generally, these additional back-end processes are performed over the period of anywhere from several hours to several days, and may delay the conversion of credit and debit posting at the BOFD from a temporary, or intermediate, memo post to a final post. The back-end processes include sorting and forwarding the check or payment information to the receiving bank (payor/endpoint). The check or payment information is sent to the receiving bank (payor/endpoint) in batches based upon a certain specified period of time or specified volume threshold being reached. Upon receipt of the check or payment information from the BOFD, the receiving bank (payor/endpoint) will perform similar deposit and back-end processes to those of the BOFD prior to entering a final posting of the credits or debits associated with that item. Further, after all processing is completed at both the BOFD and receiving bank (payor/endpoint), adjusting transactions may be created and exchanged if any processing errors or fraudulent conditions have been encountered. These adjusting entries are performed over the period of anywhere from several hours to several days. Generally, the processed check and payment item images are stored in an image archive or repository by the BOFD and for future use and may also be stored in an image archive or repository by the receiving bank (payor/endpoint).

### SUMMARY

Methods, systems, and apparatus, including computer programs encoded on a computer storage medium, are disclosed for real-time and/or online straight-through processing, including forward presentment and return processes for checks and other electronic payment instruments. In one aspect, an image file and transit item associated with a payment item received at a first financial institution are generated during a customer transaction. The image file and item are transmitted to a second financial institution associated with the payment item during the customer transaction performed at the incoming system. The image file and item are then processed and posted at the second financial institution in real-time, with a posting results notification being returned to the first system. Still during the customer transaction, the first financial institution performs a posting operation based on the posting results notification, thereby allowing the customer and financial institutions to complete the crediting and debiting of the associated accounts during the customer transaction.

The details of one or more embodiments of the present disclosure are set forth in the accompanying drawings and the description below. Other features, objects, and advantages of the present disclosure will be apparent from the description and drawings, and from the claims.

### DESCRIPTION OF DRAWINGS

FIG. 1 is a general schematic diagram of a system for performing real-time and/or online straight-through processing for the forward presentment and return presentment of checks and other electronic payment items.

FIG. 2 is a flowchart illustrating an example method for performing real-time and/or online, straight-through processing for the forward presentment of a check or other electronic payment item from the perspective of the bank of first deposit (BOFD) in accordance with the system of FIG. 1.

FIG. 3 is a flowchart illustrating an example method for performing real-time and/or online, straight-through processing for the forward presentment of a check or other electronic payment item from the perspective of a receiving bank (payor/endpoint) or financial institution associated with the check or other electronic payment item received at the bank of first deposit (BOFD) in accordance with the system of FIG. 1.

FIG. 4 is an example signaling and flow diagram illustrating operations associated with performing real-time and/or online, straight-through processing for the forward presentment of a check or other electronic payment item, including the operations of a teller system, a middle tier architecture and host system associated with a bank of first deposit (BOFD), and a middle tier architecture and host system associated with a receiving bank (payor/endpoint) associated with the check and other electronic payment item, in accordance with the system of FIG. 1.

FIG. 5 is a flowchart illustrating an example method for performing online check or electronic payment item return presentment associated with an online and/or real-time straight-through processing forward presentment of a check or other electronic payment item from the perspective of a receiving bank (payor/endpoint) or financial institution associated with the check or payment item, in accordance with the system of FIG. 1.

FIG. 6 is a flowchart illustrating an example method for performing online check or electronic payment item return presentment associated with an online and/or real-time straight-through processing forward presentment of a check or other electronic payment item from the perspective of a bank of first deposit (BOFD) in accordance with system of FIG. 1.

FIG. 7 is a flowchart illustrating an example method for performing real-time and/or online straight-through check or electronic payment item processing, including integrated forward presentment and return presentment from the perspective of a bank of first deposit (BOFD) associated with the depositor of the check or payment item, in accordance with the system of FIG. 1.

FIG. 8 is a flowchart illustrating an example method for performing real-time and/or online straight-through check or electronic payment item processing, including integrated forward presentment and return presentment from the perspective of a receiving bank (payor/endpoint) or financial institution associated with the maker of the check or payment item, in accordance with the system of FIG. 1.

FIG. 9 is a flowchart illustrating a continuation of the example methods of FIGS. 7 and 8 for performing real-time and/or online straight-through check or electronic payment item processing, including integrated forward presentment and return presentment from the perspective of the BOFD associated with the depositor of the check or payment item.

FIG. 10 is an example signaling and flow diagram illustrating operations associated with performing real-time and/or online straight-through check or electronic payment item processing, including integrated forward presentment and return presentment processes, including the operations of a teller system, a middle tier architecture and host system associated with a bank of first deposit (BOFD), and a middle tier architecture and host system associated with a receiving bank (payor/endpoint) associated with the maker of the check or other payment item, in accordance with the system of FIG. 1.

### DETAILED DESCRIPTION

The present disclosure describes systems and methods for performing real-time and/or online straight-through processing for forward presentment and return presentment of checks and other electronic payment items at a bank of first deposit (BOFD) and at receiving (payor/endpoint) banks Generally, the present disclosure describes systems and methods wherein checks and/or other electronic payment items (e.g., a loan document, a direct deposit account entry, etc.) are presented to a BOFD through an initial deposit point including teller or teller-related application (including ATMs, customer-based web applications, merchant applications, automated clearing house (ACH), etc.), and are subsequently processed and finalized in real-time, where available, by a middle tier architecture associated with the BOFD. In other words, the processing of the check or electronic payment item may be performed immediately and in a straight-through manner, avoiding current check processing systems' requirements of significant and time-consuming processing performed apart from and outside of the bank's middle tier architecture, which in turn adds significant delay to finalizing and completing transactions. In general, straight through processing may be understood to include optimization of the speed at which transactions are processed. In some instances, the optimization may include allowing information that has been electronically entered by one party to be transferred to another party in the settlement process without manually re-entering the same information repeatedly over the end-to-end sequence of events. The middle tier architecture described herein can be used to provide straight-through processing to allow improved speeds and optimizations in inter-party and intra-party transactions. The real-time processes described herein are intended to represent operations performed at a speed operable to interact and/or complete while a user, customer, or employee is actively interacting with the system (i.e., during a deposit transaction). In some instances, a real-time process may be able to provide a completed transaction at both the point of deposit (i.e., the BOFD) and the associated receiving (payor/endpoint) bank, such that a receipt provided at the point of deposit may represent an actual, completed transaction at both financial institutions. An online process may include processes performed, for example, within the middle tier architecture, but not in real-time (i.e., during the active interaction with the customer).

One advantage of performing the check or payment item validation and processing in a real-time and/or online straight-through manner is that the need for memo, or temporary, posting to a bank's host system may be removed, such that only a final post is required. In this manner, the check or payment item is immediately processed and finalized at the BOFD and the receiving (payor/endpoint) bank, removing the need for check or payment item processing outside of the middle tier architecture's in-line systems, and, in most cases, allowing customers to receive a receipt reflecting a completed transaction during their real-time interactions with the BOFD.

In addition to the real-time and/or online straight-through processing performed at the BOFD, the receiving (payor/endpoint) bank can be provided with an image file representing the received check or payment item once the check or payment item has been scanned at the initial deposit point. In some instances, an initial review of the scanned image file can be performed at the BOFD's teller or middle tier architecture such that an expected receiving (payor/endpoint) bank of the check is determined (for instance, using information encoded in the MICR line of the received image file associated with the payment item). Once the expected receiving (payor/endpoint) bank is determined, the middle tier of the architecture of the BOFD transmits the scanned image file to the receiving (payor/endpoint) bank prior to any additional processing, providing the receiving (payor/endpoint) bank's middle tier architecture with the image file prior to any additional data being received. In this manner, the typically time-consuming process of providing large image files (at least compared to the data and information extracted from the check or payment file) can be performed immediately, in most cases allowing the image file associated with a deposited check to arrive at the receiving (payor/endpoint) bank prior to completion of the processing performed at the BOFD. Once the initial deposit processing and middle tier architecture processing at the BOFD is completed, any additional content and verification data will then be provided to the receiving (payor/endpoint) bank. Because the scanned image files are orders of magnitude larger than the data extracted from the scanned check or payment item, the initial transmission to and receipt of the scanned image file at the receiving (payor/endpoint) bank can allow for immediate check processing at the receiving (payor/endpoint) bank once the BOFD completes its real-time and/or online straight-through processing. In addition, the receiving bank can perform a real-time and/or online posting and return analysis of the check or electronic payment item received through the middle tier, allowing return information to be sent back to the BOFD. In some instances, the customer at the BOFD may be notified of issues with his or her deposit at the time of the deposit where a real-time analysis and determination is made at the receiving (payor/endpoint) bank. In other instances, the BOFD may be notified of issues with the deposit within minutes or hours where an online (but not real-time) analysis and determination is made at the receiving (payor/endpoint) bank. These instances are opposed to the multi-day batch process currently used by financial instructions. In cases where multiple items are included in a single deposit, each item may be processed individually as concurrent process threads as opposed to performing a batch process.

Generally, transmissions between the BOFD and the receiving (payor/endpoint) bank will be performed between the respective middle tier architectures of the two systems, allowing for consistent and immediate communications between the middle tier architectures using common formats and communication protocols. Another advantage of the system in the present disclosure is that the system is infinitely scalable, in that middle tier architectures associated with any number of individual banks or other financial institutions can be added to the system, such that the middle tier architectures are loosely coupled to each other. Using secure networking protocols, the BOFD can transmit and receive information from any bank associated with and communicably coupled to the present system, allowing for consistent connections and communications of checks and electronic payment items between systems, and allowing for real-time processing and presentment of checks and electronic payment items. Still further, transactions that require no additional human or manual interaction processes at the middle tier architecture after receipt from the initial deposit point can be immediately sent to the receiving (payor/endpoint) bank. The present disclosure allows for real-time processing and presentment across any and all associated systems. Further, data transmission times can be minimized by separating the processes of the sending of scanned images to the receiving (payor/endpoint) bank from the sending of the related verification and check-based data and information, allowing the high bandwidth required by the image file transmission to be performed while the image file processing is being performed, thereby allowing the receiving (payor/endpoint) bank to immediately process a check or payment item while the BOFD completes its processing.

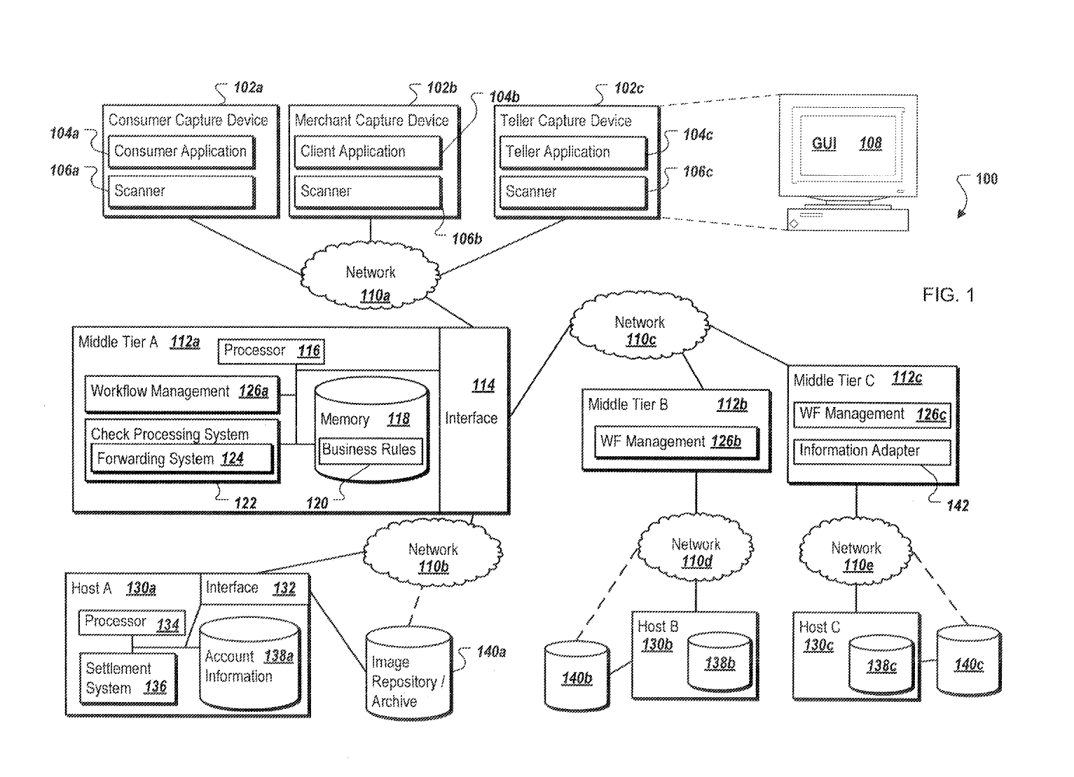

FIG. 1 illustrates a system 100 for performing real-time and/or online straight-through processing for forward presentment and return presentment of checks and other electronic payment items at a BOFD, as well as real-time and/or online straight-through processing for forward presentment and return presentment of checks and other electronic payment items at one or more receiving (payor/endpoint) banks in accordance with one embodiment of the present disclosure. Generally, system 100 includes at least a portion of any (and one or more) financial or banking system(s) operable to process commercial paper transactions (such as checking), generate or process image files associated with one or more checks or electronic payment items for at least one transaction, and securely process, validate, and transmit these one or more checks and/or electronic payment items. For example, system 100 may receive a physical check at one of a plurality of associated locations, including at a teller 102c located within a particular branch or location of a BOFD (e.g., Bank A, a financial institution associated with middle tier A 112a and host A 130a), a merchant capture location 102b associated with a merchant affiliated with Bank A, or a consumer capture device 102a with software and hardware that may allow a consumer to present a check or other electronic payment item for presentment via the consumer capture device 102a. Using scanners 106a, b, and c associated with each of the respective devices, locations, or entities, image files of a physical check may be generated. In general, the image files of the received physical checks may include images of the front, the back, or both of the check or payment item, as well as a capture of the MICR line of the check. The image files may be in any suitable format including Moving Picture Experts Group (MPEG), Joint Photographic Experts Group (JPEG), Tag Image File Format (TIFF), including any suitable version thereof (such as TIFF 6.0), and others. In some instances, additional information may be provided at the respective locations or devices that may allow users of or at those locations to include additional information or metadata with the image file associated with the check, either as metadata associated with the file, one or more additional information files, or information included within the image files themselves.

The consumer capture device 102a may be a general purpose device or personal computer including or associated with a scanner 106a (e.g., a flatbed scanner, a multi-function printer with scanning capabilities, etc.) or another device capable of capturing images of the associated check or payment item. In some instances, the consumer capture device 102a may include a mobile device, such as a smartphone, in which the device's camera may be used in lieu of a traditional scanner to capture the image of the check or payment item. Additionally, the consumer capture device 102a may include or be loaded with a consumer capture application 104a that allows the consumer capture device 102a to perform check receiving and capturing operations and transmit the captured images and other relevant information to a particular bank, such as Bank A, via middle tier A 112a. As illustrated in FIG. 1, consumer capture device 102a may communicate its scanned image files to or via network 110a with middle tier A 112a of Bank A.

The merchant capture device 102b may be any device associated with a remote deposit system, or the ability to deposit checks and other electronic payment items into a bank account from a merchant location (and/or residence) without requiring the customer, whether a business or consumer, to physically deliver the actual check or payment item to the BOFD. Similar to the consumer capture device 102a, the merchant capture device 102b uses a scanner 106b or other means to scan a digital image of a check onto a computer (e.g., a personal computer, a cash register, etc.), and transmit the image file result of the scanning to the associated bank using a client capture application 104b. In some instances, the client capture application 104b may be a Web-based or online application that can be accessible to the customer via an Internet connection, while in other instances, the client capture application 104b may be a client-based application executed locally on the merchant capture device 102b capable of using a network connection to transmit the scanned image files and, in some instances, any additional information provided by the customer or extracted/determined by the client capture application 104b, to the associated financial institution (here, Bank A).

Teller capture device 102c represents the traditional teller experience and devices associated with a personal teller or financial institution representative at a bank. In this instance, a typical teller-customer interaction is considered, where the customer may provide one or more checks or payment items to the teller, who in turn may use a scanner 106c associated with a teller application 104c to capture, process, and transmit check or payment item information to the associated middle tier A 112a of the respective financial institution. Additionally, the teller capture device's scanner 106c (as well as scanners 106a and b) may also include a MICR reader for capturing MICR-line check data from the received check or payment item, in addition to a digital image of the MICR line itself. The teller capture device 102c may be a general purpose computer located at the corresponding financial institution, or the teller capture device 102c may be specifically designed or generated for receiving, scanning, and processing incoming check and payment items. In either event, the teller capture device 102c is capable of capturing the requisite images associated with the received check, generating a suitable image file storing said images, and transmitting that data to the associated middle tier A architecture 112a associated with the teller capture device 102c. In some instances, the teller capture device 102c may execute a browser-based teller solution.

Teller capture device 102c is further illustrated as including a graphical user interface (GUI) 108. The GUI 108 comprises a graphical user interface operable to, for example, allow the user of the teller capture device 102c to interface with at least a portion of the teller capture application 104c, as well as any other purpose associated with the teller capture device 102c, such as creating, preparing, requesting, or analyzing data, as well as viewing and accessing customer account information associated with financial transactions. Generally, the GUI 108 provides the particular user with an efficient and user-friendly presentation of business data provided by or communicated within the system. The GUI 108 may comprise a plurality of customizable frames or views having interactive fields, pull-down lists, and buttons operated by the user. For example, GUI 108 may provide interactive elements that allow a user to enter or select data associated with financial transactions in GUI 108. More generally, GUI 108 may also provide general interactive elements that allow a user to access and utilize various services and functions of teller capture application 104c. The GUI 108 is often configurable, can support a combination of tables and graphs (bar, line, pie, status dials, etc.), and may be able to access one or more web sites associated with financial transactions. Therefore, the GUI 108 contemplates any suitable graphical user interface, such as a combination of a generic web browser, intelligent engine, and command line interface (CLI) that processes information in the platform and efficiently presents the results to the user visually. Although not illustrated as such, both consumer capture device 102a and merchant capture device 102b include GUIs allowing users of those devices to perform similar operations and enter information associated with financial transactions (including the corresponding applications), as well as other operations incidental to the use of those devices.

Generally, the consumer capture device 102a, merchant capture device 102b, and teller capture device 102c may be communicably coupled with a network 110 that facilitates wireless or wired communications between the components of the environment 100 (i.e., between the described devices 102 and middle tier architecture 112a), as well as with any other local or remote computer, such as additional clients, servers, or other devices communicably coupled to network 110 but not illustrated in FIG. 1. In the illustrated environment, the network 110 is depicted as multiple continuous and discontinuous networks or connections between various components in FIG. 1 (e.g., networks 110a-e). However, network 110 may be a single network without departing from the scope of this disclosure, so long as at least a portion of the network 110 may facilitate communications between senders and recipients. The network 110 may be all or a portion of an enterprise or secured network, while in another instance, at least a portion of the network 110 may represent a connection to the Internet. In some instances, a portion of the network 110 may be a virtual private network (VPN), such as, for example, the connection between the consumer capture device 102a and the middle tier A 112a. Further, all or a portion of the network 110 can comprise either a wired or wireless link. Example wireless links may include 802.11a/b/g/n, 802.20, WiMax, and/or any other appropriate wireless link. In other words, the network 110 encompasses any internal or external network, networks, sub-network, or combination thereof operable to facilitate communications between various computing components inside and outside the illustrated environment 100. The network 110 may communicate, for example, Internet Protocol (IP) packets, Frame Relay frames, Asynchronous Transfer Mode (ATM) cells, voice, video, data, and other suitable information between network addresses. The network 110 may also include one or more local area networks (LANs), radio access networks (RANs), metropolitan area networks (MANs), wide area networks (WANs), all or a portion of the Internet, and/or any other communication system or systems at one or more locations. Different portions of the network 110 may be distinct from other portions in order to compartmentalize or limit the interactions and communications sent between components. For instance, the consumer capture device 102a may not be able to communicate over network 110e (the connection between middle tier C 112c and host C 130c. Additionally, communications across the network 110 may be encrypted in order to protect the transmitted data, and may be encrypted using protocols and encryption methods supported and/or required by the financial services industry, regulatory agencies, and other requirements or standards.

Once a check or payment item is captured by a receiving device (i.e., the consumer capture device 102a, the merchant capture device 102b, or the teller capture device 102c), the image file associated with the captured and scanned check or payment item is sent to middle tier A 112a. In some instances, middle tier A 112a comprises one or more application servers providing an event-driven middleware system that provides business-rule integration across one or more financial organizations, including the processing of financial transactions, such as operations for check and electronic payment item processing. In general, middle tier A 112a may be any server (or set of servers) that stores one or more check processing systems 122, where at least a portion of the check processing system 122 is executed via requests and responses sent between the various devices 102a-c communicably coupled with the middle tier A 112a. The check processing system 122 can perform any number of operations on received images associated with checks and payment items, including MICR codeline verification, image quality analysis, amount keying, fraud detection, and suspect review. Generally, these processing steps analyze the received document to determine additional information included within the associated payment instrument, while also confirming any information received with the image files from the consumer capture application 104a, the merchant client capture application 104b, the teller capture application 104c, or any other source of incoming payment items associated with the middle tier A 112a.

Each middle tier, including middle tier A 112a, may include a respective workflow management component 126a for monitoring and managing logical units of work including interactions associated with the check processing systems 122, communications between the middle tiers 112a/b/c, and other operations. The workflow management component 126a may identify and/or enforce one or more business rules associated with a particular transaction. For instance, some transactions may be associated with a time limit or time out value or parameter used to manage real-time processing. If, during the processing of the deposit, the time out value is exceeded, the workflow management component 126a may be capable of having the respective middle tier 112a perform a memo, or other temporary posting, to avoid deposit customers or users waiting past a particular threshold. In those instances, the associated process may continue in an online, but not real-time, manner. In some instances, the workflow management component 126a may monitor and manage processes performed on a single middle tier 112a, while in other instances, the workflow management component 126a may monitor processes or events performed across middle tier boundaries. In those instances, the workflow management component 126a may be in communication with the workflow management components 126b/c located at the middle tiers of other financial institutions. In general, the workflow management component 126a can control the execution of various concurrent processes performed for the completion of receiving and processing deposits across the described system, including the entire (or a portion of the) end-to-end process. In the case of anomalies during execution of a process, the workflow management component 126a may be capable of taking appropriate actions in response to those anomalous events. In some instance the operations of the workflow manager 126a may be embedded within, performed by, or associated with the check processing system 122 or another suitable portion of the various middle tiers.

In one example, the middle tier A 112a may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, middle tier A 112a may store a plurality of related applications and processes, while in other instances, the middle tier A 112a may be a dedicated server meant to store and execute only a single check processing system 122. In some instances, the middle tier A 112a may comprise a web server or be communicably coupled with a web server, where the check processing system 122 represents one or more web-based applications accessed and executed via network 110 by clients of the system to perform the programmed tasks or operations of the check processing system 122.

At a high level, the middle tier A 112a comprises an electronic computing device operable to receive, transmit, process, store, or manage data and information associated with the environment 100. The middle tier A 112a illustrated in FIG. 1 can be responsible for receiving application requests from one or more client applications (e.g., the consumer capture application 104a, the merchant client capture application 104b, or the teller capture application 104c) or business applications associated with one or more other middle tier systems (112b-c) within environment 100, and responding to the received requests by processing said requests in the associated check processing system 122, and sending the appropriate response from the check processing system 122 back to the requesting application. Alternatively, the check processing system 122 at the middle tier A 112a can be capable of processing and responding to requests from a user accessing the middle tier A 112a locally. For example, one or more quality assurance professionals may have local access to the middle tier A 112a to perform any necessary quality checks and/or manual keying and corrections required after initial processing and validation from the check processing system 122. Accordingly, in addition to requests from the external systems and applications illustrated in FIG. 1, requests associated with the check processing system 122 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the term “computer” is intended to encompass any suitable processing device. For example, although FIG. 1 illustrates middle tier A 112a as a single server, middle tier A 112a can be implemented using two or more servers, as well as computers other than servers, including a server pool. Indeed, middle tier A 112a may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated middle tier A 112a may be adapted to execute any operating system, including Linux, UNIX, Windows, Mac OS, or any other suitable operating system.

In the present implementation of FIG. 1, middle tier A 112a includes a processor 116, an interface 114, a memory 118, a workflow management component 126a, and the check processing system 122. The interface 114 is used by the middle tier A 112a for communicating with other systems in a client-server or other distributed environment (including within environment 100) connected to network 110 (or one or more subsets thereof, such as networks 110a-c), including one or more other middle tiers associated with other financial institutions (e.g., middle tier B 112b and middle tier C 112c), as well as host A 130a associated with middle tier A 112a. Generally, the interface 114 comprises logic encoded in software and/or hardware in a suitable combination and operable to communicate with the network 110. More specifically, the interface 114 may comprise software supporting one or more communication protocols such that the network 110 or interface's hardware is operable to communicate physical signals within and outside of the illustrated environment 100.

As illustrated in FIG. 1, middle tier A 112a includes a memory 118 for storing data and program instructions, the memory 118 including a set of business rules 120 associated with middle tier A 112a and its associated check and electronic payment item processing operations, including financial institution-specific parameters and rules that may differ from other financial institutions, as well as parameters and rules shared among a plurality of related financial institutions. Memory 118 may include any memory or database module and may take the form of volatile or non-volatile memory including, without limitation, non-transitory magnetic media, optical media, random access memory (RAM), read-only memory (ROM), removable media, or any other suitable local or remote memory component. Memory 118 may store various objects or data, including classes, frameworks, applications, backup data, business objects, jobs, web pages, web page templates, database tables, repositories storing business and/or dynamic information, business rules, and any other appropriate information including any parameters, variables, algorithms, instructions, rules, constraints, or references thereto associated with the purposes of the middle tier 112a and its check processing system 122.

As noted, memory 118 is illustrated as storing a set of business rules 120 that can determine specific parameters and rules associated with middle tier A 112a and its check processing system 122. For example, the business rules 120 may determine or specify the appropriate data formats to be used for various files associated with and used by the middle tier A 112a, as well as information on what data formats should be used in association with operations with one or more other financial institutions (or portions thereof, such as a second financial institution's middle tier B 112b). As described, some or all of the business rules 120 may be specific to a particular middle tier or financial institution, while some may also be similar or identical among a plurality of financial institutions and middle tiers. In some instances, the business rules 120 may determine financial institution-specific operations and procedures for handling and processing various items, including fraud-based operations and responses. In some instances the business rules 120 may be a static set of rules or parameters, while in others, they may be able to be modified by an administrator or other user.

As illustrated in FIG. 1, middle tier A 112a includes a processor 116. Although illustrated as a single processor 116 in FIG. 1, two or more processors may be used according to particular needs, desires, or particular embodiments of environment 100. Each processor 116 may be a central processing unit (CPU), a blade, an application specific integrated circuit (ASIC), a field-programmable gate array (FPGA), or another suitable component. Generally, the processor 116 executes instructions and manipulates data to perform the operations of middle tier A 112a and, specifically, the check processing system 122. Specifically, the middle tier A's processor 116 executes the functionality required to receive and respond to requests from various components and their respective applications, as illustrated in FIG. 1, as well as the functionality required to perform the other operations of the check processing system 122.

Regardless of the particular implementation, “software” may include computer-readable instructions, firmware, wired or programmed hardware, or any combination thereof on a tangible, non-transitory, medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated environment 100, processor 116 executes the check processing system 122 on the middle tier A 112a.

Some general operations of the check processing system 122 are described above. In addition, the check processing system 122 may also include a forwarding system (or application) 124 that determines the destination (i.e., a receiving bank/payor/endpoint) of a particular check or payment item. In the present example, the forwarding system 124 may receive the image file associated with a received check and use that image file, along with any information received or derived at the initial deposit point (102a-c), to determine an expected destination (endpoint), of the received check. In doing so, the forwarding system may identify a particular bank or other financial institution to which the received check is associated. For example, information derived from the MICR line (e.g., through optical character recognition (OCR), an initial scan of the MICR line, or information manually keyed) may be used to identify a particular receiving bank on which a check or payment item is drawn. The forwarding system 124 (and in some cases, the check processing system 122) can then determine the corresponding middle tier associated with that particular receiving (payor/endpoint) bank or financial institution. In order to drastically decrease the processing time of the check or payment item, the check processing system 122 may immediately (or shortly after receipt of the image file) transmit the image file to an appropriate corresponding and communicably coupled middle tier via network 110c. In general, the transmission of the image file associated with the received check or electronic payment item is a much more data- and time-intensive process than transmission of data and other information associated with the check or electronic payment item. By sending the image file immediately upon receipt at the middle tier, or close thereto, the processing time required of the check or payment item throughout the entire system (i.e., the initial middle tier and the second middle tier) can be reduced. For instance, once the image file is sent to the second middle tier of a corresponding second financial institution, the second financial institution's middle tier will be ready to process the check or payment item's image file and associated validation and payment data immediately once the BOFD's middle tier (A 112a) completes its validation and processing operations and provides a transit item or additional information associated with the already-sent image file.

After sending the image file of the received check or payment item, the check processing system 122 performs various levels of check or payment item processing and validation in order to complete the analysis and handling of the received item. In some examples, the check processing system 122 can determine what the level of additional processing necessary for a particular received item may be, and route the image file and associated data of that received item to the appropriate next process point within system 100. For example, the check processing system 122 may first send the received check or payment item to an image analysis module to determine whether the quality of the received image file is sufficient for further processing. Additionally, the MICR codeline read and processing during the initial scanning (e.g., at the teller device 102c) may be compared to the MICR codeline information included within the image file to determine if the information is consistent. Additionally, the check processing system 122 can determine if any amounts or other information not received or input at the initial deposit point device is required to complete and/or continue processing. Still further, the check processing system 122 may run the image file and associated information through one or more suitable fraud detection algorithms and/or systems. If any issues are identified during the check processing system's 122 operations, the check processing system 122 can provide the information associated with the check or payment item to a local or remote bank or financial institution representative, employee, or contractor, who can manually perform any additional processing steps required to correct the issues identified during the check processing operations. In most cases, the information received at the initial deposit point devices will be sufficient, and the check processing system 122 may continue its operations.

Once the check or payment item completes its validation and general processing as described above, the check processing system 122 forwards data associated with the received and/or processed check or payment item to a host system A 130a associated with the check processing system's middle tier A 112a. In general, information detailing any credits and/or debits associated with the payment item is sent to the host system A 130a in order to settle the accounts associated with the check or payment item, and update any accounts maintained at the host system A 130a. In parallel with the sending the information to the host system A 130a, the middle tier A 112a (via the check processing system 122) can forward the finalized set of data and information associated with the processed check to the receiving (payor/endpoint) bank determined and confirmed during the check processing system's operations. In some instances, the confirmed receiving bank (payor/endpoint) may differ from the receiving bank (payor/endpoint) to which the image file was initially sent. In those instances, the image file may be resent by the middle tier A 112a, this time to the newly determined and correct receiving (payor/endpoint) bank (or middle tier). Further, the middle tier A 112a can forward the finalized information to host system A 130a (the host system associated with middle tier A 112a) that can perform the actual settlement operations and actions of processing the credits and debits of those accounts maintained or managed by the financial institution or bank associated with middle tier A 112a and host system A 130a.

Once middle tier A 112a finalizes its processing operations, the middle tier A 112a sends the results of the processing to its associated host system A 130a via network 110b and the interfaces (114, 132) of each system. In general, host system A 130a applies the credits and debits associated with the received checks and payment items to one or more accounts of the associated financial institution. For instance, if the check or payment item received at the initial point of deposit represented a check written to a customer of the financial institution, after processing and receiving the corresponding information from middle tier A 112a, the host system A 130a would apply the appropriate credit to the account associated with the customer by updating the customer's account information. Once the credit (or debit in cases) is applied, the host system A 130a can return that information to middle tier A 112a, confirming the application of the credit (or debit) has been performed.

Similar to middle tier A 112a, the host system A 130a may comprise one or more application servers used to maintain and monitor the accounts of customers associated with a financial institution. As illustrated, the host system A 130a includes an interface 132, a processor 134, a settlement system application 136, and memory representing a set of account information 138a associated with the customers of the financial institution. In general, the interface 132 and the processor 134 of the host system A 130a may be similar to the interface 114 and processor 116 described above in relation to middle tier A 112a, although any suitable alternative type of interface and/or processor(s) may be used with the host system A 130a in various embodiments or implementations. In general, the processor 134 executes instructions and manipulates data to perform the operations of host system A 130a and, specifically, the settlement system 136. Specifically, the host system A's processor 134 executes the functionality required to receive and respond to requests from various components and their respective applications as illustrated in FIG. 1, as well as the functionality required to perform the other operations of the settlement system 136.

The settlement system 136 is any software used to receive and interpret information from corresponding middle tier A 112a regarding received transactions resulting in a credit and/or debit to an account maintained by the host system A 130a. As described in the present disclosure, middle tier A 112a performs the processing and validation of received check and payment item transactions prior to forwarding information to host system A 130a. As such, the host system A 130a, and in turn, the settlement system 136, receive a finalized set of credit and debit information from the middle tier A 112a that can be posted as a final post transaction to the corresponding account (or accounts) maintained by the host system A 130a. The settlement system 136 can interact directly with the account information 138a to update (i.e., credit or debit) the appropriate accounts of customers according to the information received from middle tier A 112a. Importantly, the final post of the transaction to a customer's account can be used to complete a transaction, and complete the primary processing performed at the first financial institution (i.e., the bank associated with middle tier A 112a and the host system 130a). Once the final post is performed, the settlement system 136 can return a confirmation to the middle tier A 112a notifying the middle tier that the associated settlement operations at the host system A 130a have been performed. In instances where the middle tier's processing identifies one or more issues with the received check or payment item image file or associated data, the settlement system 136 may be directed to apply a memo (or temporary) post to the associated customer account information 138a. Once the settlement system 136 receives information confirming the middle tier A's 112a completion of processing the corresponding check or payment item, the settlement system 136 can modify the memo post to a completed final post, either confirming the transaction information associated with the memo post or modifying the transaction information to match the information resulting from the middle tier A's 112a processing operations.

The account information 138a stored at the host system A 130a may be stored in memory similar to that described in regard to memory 118, as well as any other suitable memory. Further, the account information 138a may be stored locally on the host system A 130a, as illustrated in FIG. 1, while in alternative instances, all or a portion of the account information 138a may be stored remote from the host system A 130a. The account information 138a itself may be stored as any appropriate type of file, including a relational database, a mainframe database, a text file, a flat file, or any other suitable storage file or mechanism.

In general, host systems 130 and their corresponding middle tiers 112 can communicate using multiple message formats and over multiple communication protocols. Further, communications between host systems and middle tiers may be encrypted using any suitable encryption technique in order to protect the sensitive information transmitted between the systems. In some instances, middle tiers may correspond with host systems using message queuing (MQ), a queue-based communication protocol. System developers can define queues for a targeted communication end point. The two systems communicating with each other through the queue do not have to be active at the same time, which makes MQ suitable for asynchronous communication. In other embodiments, TCP/IP-based communications, hypertext transfer protocol (HTTP) communications, and various legacy communication techniques, may be used to communicate between the systems. The legacy communication techniques may include an SNA data service that supports LU2 and LU6.2 communication. In practice, any suitable method of communication may be used to communicate information between the host systems 130 and their respective middle tiers 112.

Once the host system 130a completes its update of the account information, the host system 130a may send a confirmation of completed transaction to the middle tier A 112a. The confirmation may be received by middle tier A 112a while the customer continues interactions with the teller (or other initial deposit points). In those instances, the operations of the present disclosure can allow issuance of a transaction receipt confirming a completed account transaction reflecting the final posting of the transaction to the customer's account at the corresponding financial institution.

Additionally, after processing is completed, the generated and processed image file may be stored in an image repository and/or image archive 140a, either by the middle tier A 112a or by the host system A 130a. The image repository and/or image archive 140a may be used to store image files for backup purposes, as well as to satisfy regulatory and legal obligations associated with the management of financial transaction information. The image repository and/or image archive 140a may be local or remote to the corresponding financial institution, and information may be sent via a portion of the network 110 (here, network 110b) through the interface 114 of the middle tier A 112a (and/or the interface 132 of the host system A 130a) to the location at which the image repository and/or archive 140a is located. In some instances, the image repository and/or image archive 140a may be dedicated to a single financial institution, middle tier, and/or host system, while in other instances, the image repository and/or image archive 140a may be used by a plurality of financial institutions to store the required image files (and associated data). In some instances, financial institutions may use a separate image repository and an image archive for different purposes. For instance, the image repository may be used for short-term storage, while the image archive may be used for long-term storage (either according to business rules defined for a particular financial institution, or by regulatory or legal requirements defined by an outside agency or industry group). As illustrated, each financial institution (i.e., middle tier and host system) may be associated with an image repository and/or archive (140b, c).

Once the transaction is finalized, and the middle tier A 112a receives confirmation from the corresponding host system A 130a, one or more transit items associated with the transaction are generated by middle tier A 112a comprising the set of transaction information and data associated with the received (and now processed) check or payment item. The transit items are generated and sent to be associated with the image files previously sent to the destination middle tier associated with the receiving financial institution (payor/endpoint), and which are to be provided to the receiving financial institution for presentment via the corresponding middle tier. Each check or payment item may be associated with its own transit item, allowing processed check or payment items to be sent to the receiving financial institution as soon as the middle tier and host system processing is complete. In general, both the transit item and the previously-sent image file may be associated with a common identifier, allowing the middle tier of the receiving financial institution (payor/endpoint) to immediately associate the newly received transit item data with the stored image file and begin processing the corresponding item through its middle tier and host. In some instances, the transit items generated by middle tiers may be generated in a common format unique to and/or consistent with the transactions performed between the various middle tiers illustrated in FIG. 1. In some instances, the transit items may be sent using an industry standard format, such as X9.37 files, to transmit the appropriate data between middle tier systems. In other instances, the transit items generated by the middle tier may only include information regarding debits to be covered by the corresponding financial institution. Upon presentment of the transit item (and corresponding image file), the receiving financial institution (or payor bank/endpoint) can process the transit item/image file combination according to the middle tier settings and business rules of the receiving financial institution. As illustrated in FIG. 1, transit items can be sent from middle tier A 112a to the other middle tiers (middle tier B 112b and middle tier C 112c) via network 110c, which may be a dedicated communications channel, a VPN between financial institutions, or any other network, including those described above.

FIG. 1 illustrates two additional sets of middle tiers and host systems, including middle tier B 112b and host system B 130b, and middle tier C 112c and host system C 130c. In general, a second financial institution (Bank B) may be associated with middle tier B 112b and host system B 130b, and a third financial institution (Bank C) may be associated with middle tier C 112c and host system C 130c. Further, the other middle tiers (B 112b and C 112c) may be composed of similar systems and components as that of middle tier A 112a (such as including similar processors, check processing systems, memory, and interfaces), while in other instances, one or both of the other middle tiers B 112b and C 112c may be composed of different and/or analogous components (such as including different types of processors, different check processing systems, etc.). In any event, both middle tier B 112b and C 112c are capable of receiving image files from middle tier A 112a when those files are initially sent. Those image files may be stored in the corresponding local memories of those middle tiers (not illustrated in FIG. 1), and kept until the additional information and data, including the transit items associated with those image files, are received from middle tier A 112a. Once the image file and related data corresponding to a particular check or payment item is received at middle tier B 112b or C 112c, those received files are associated together based on their corresponding unique identifiers (or another relationship identifying the relationship between the image file and/or the transit item or associated data).

Once the image file and transit item are associated at the receiving (payor/endpoint) bank, the middle tier at that financial institution performs its normal validation and processing operations. The validation and processing operations of middle tier B 112b and/or middle tier C 112c may be identical or similar to those of middle tier A 112a, or alternatively, may include additional or fewer validation and processing steps as is required by the associated financial institution. In some cases, the data received at the receiving middle tier may include information on the validation and processing steps performed by the originating (or sending) middle tier (middle tier A 112a, in this instance). In some scenarios, the validation and processing steps of the originating middle tier (middle tier A 112a, for example) may be sufficient or acceptable for validation purposes of the receiving middle tier (middle tier B 112b, for example) such that no additional validations, or only a subset of the typical validations performed by middle tier B 112b, may need to be performed. The determination of what validations are acceptable or that may cause a modification to the respective validations and processing steps at the receiving middle tier can be defined in the corresponding business rules associated with each respective middle tier system. For instance, while middle tier B 112b may accept the validations of middle tier A 112a and perform fewer validations than normal based on the operations performed at middle tier A 112a, middle tier C 112c may perform the entire set of validations and/or operations regardless of the validations performed at middle tier A 112a.

If the receiving middle tier (B 112b or C 112c) performs its normal operations, the image file and transit item may be processed similar to the initial processing performed at middle tier A 112a, including codeline verification of the scanned MICR line from the image file, an image quality analysis, an amount keying (if necessary), and fraud-related detection and suspect review. The receiving middle tiers may perform similar operations as middle tier A 112a to process the image file and transit item, or may perform alternative, additional, or different operations to perform the same. In any event, once the validation and processing of the received image file and associated data is complete, the receiving middle tier (B 112b or C 112c) sends the finalized information to the corresponding host system 130 (host system B 130b and host system C 130c). The corresponding host system 130 (host system B 130b and host system C 130c), which may include components similar to those of host system A 130a, then updates the corresponding set of account information 138b or 138c with the transaction information received from the originating financial institution. As illustrated, communications between the additional middle tiers and host systems are performed through networks 110d and 110e, which may be dedicated communication channels between the respective components or any other suitable means of communication. Once the records are updated in the corresponding sets of account information (138b or 138c), a confirmation can be sent from the host system B or C (130b or 130c) to the corresponding middle tier B or C (B 112b or C 112c), which may be forwarded back to the originating middle tier to notify of the completion of the transaction (e.g., middle tier A 112a). Additionally, each financial institution (and thus, middle tier and host system) may be associated with an image repository and/or archive 140b and 140c, respectively, to store the image files and associated data according to financial institution-specific requirements, as well as based on industry standards and regulatory requirements.

In FIG. 1, middle tier C 112c is illustrated as including an information adapter 142. The information adapter 142 can be used to translate information received from other middle tiers into a format or information set compatible with the format used in middle tier C 112c. Additionally, any information sent from middle tier C 112c may be modified by the information adapter 142 to place that information or associated data into a format compatible with one or more associated middle tiers. In some instances, the information adapter 142 may allow legacy middle tier applications to communicate and coordinate with newly-added, updated, or other non-legacy middle tiers without losing the ability to scale the system of the present disclosure.

While FIG. 1 is described as containing or being associated with a plurality of elements, not all elements illustrated within environment 100 of FIG. 1 may be utilized in each alternative implementation of the present disclosure. For example, although FIG. 1 depicts a consumer capture device 102a, a merchant capture device 102b, and a teller capture device 102c, any combination or configuration of devices may be used to receive and scan checks and payment items into the system (for example, ATMs). Further, although FIG. 1 depicts each middle tier 112 as a single application server, any or all of the middle tier architectures may include two or more servers. In some instances, one or more system administrators may be local or external to the illustrated system, and may have access to the business rules 120 of a particular middle tier in order to change local settings associated therewith. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

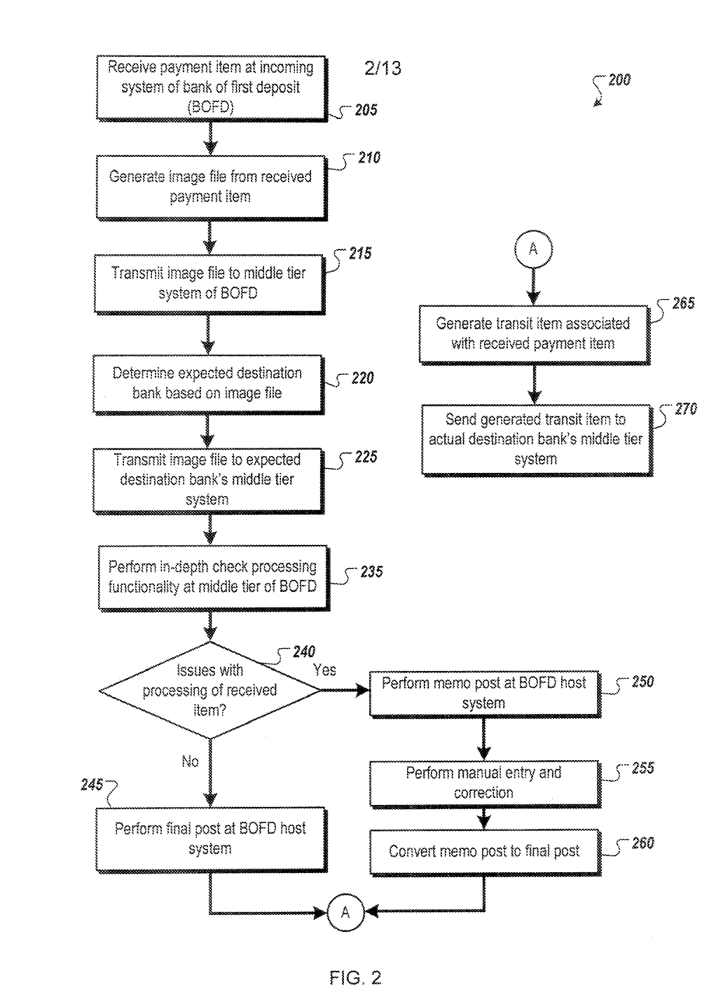

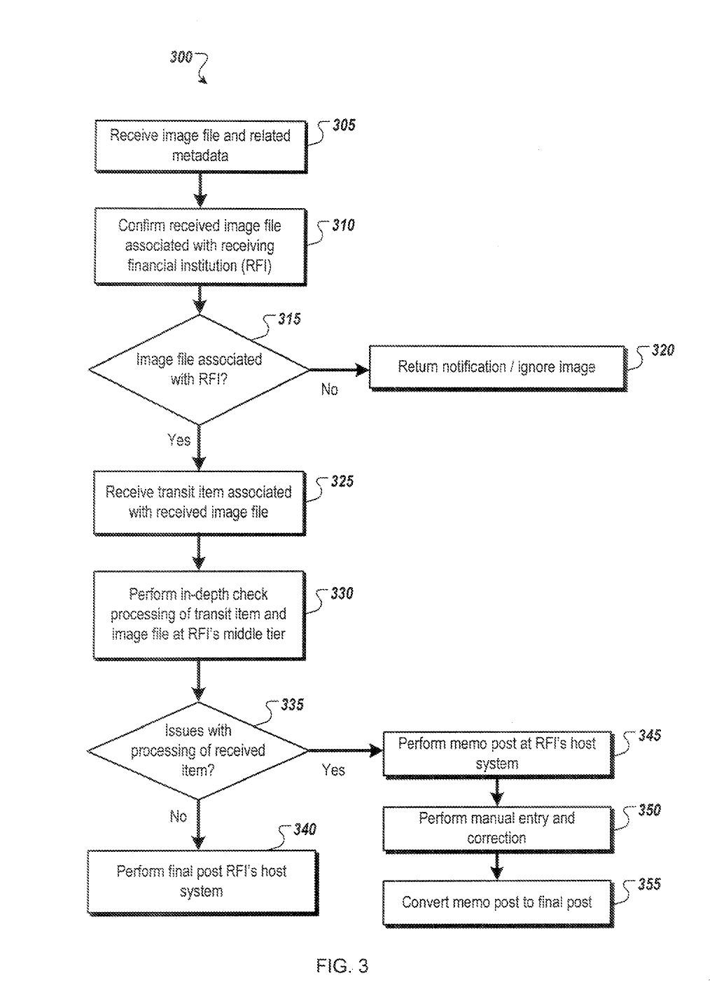

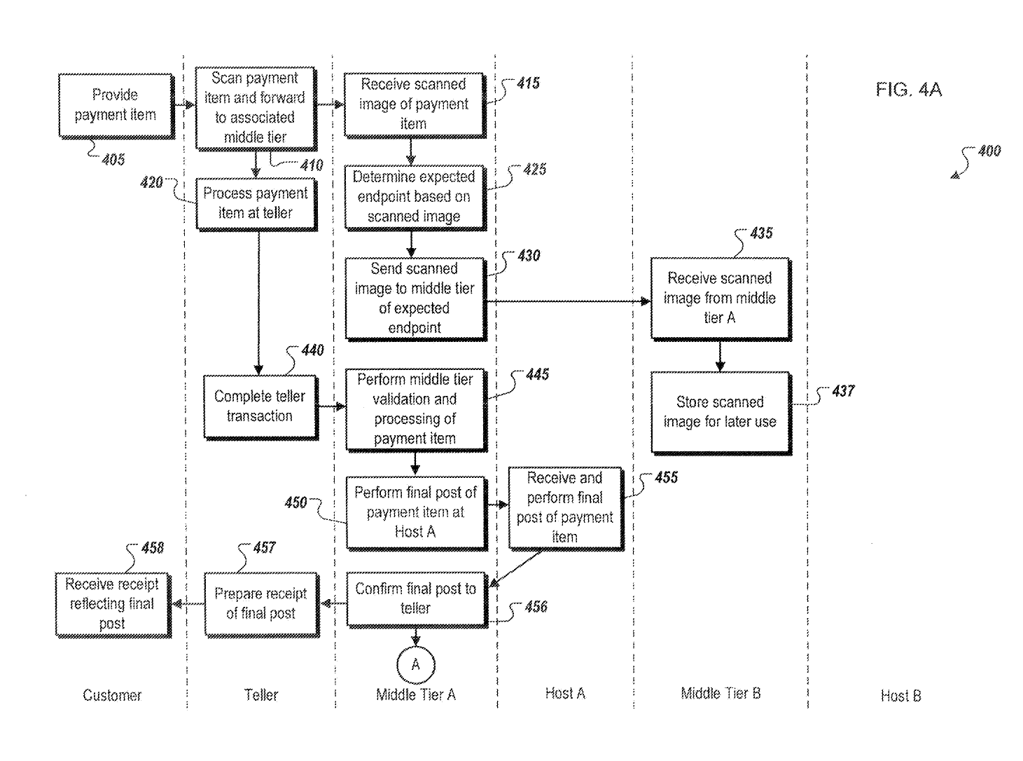

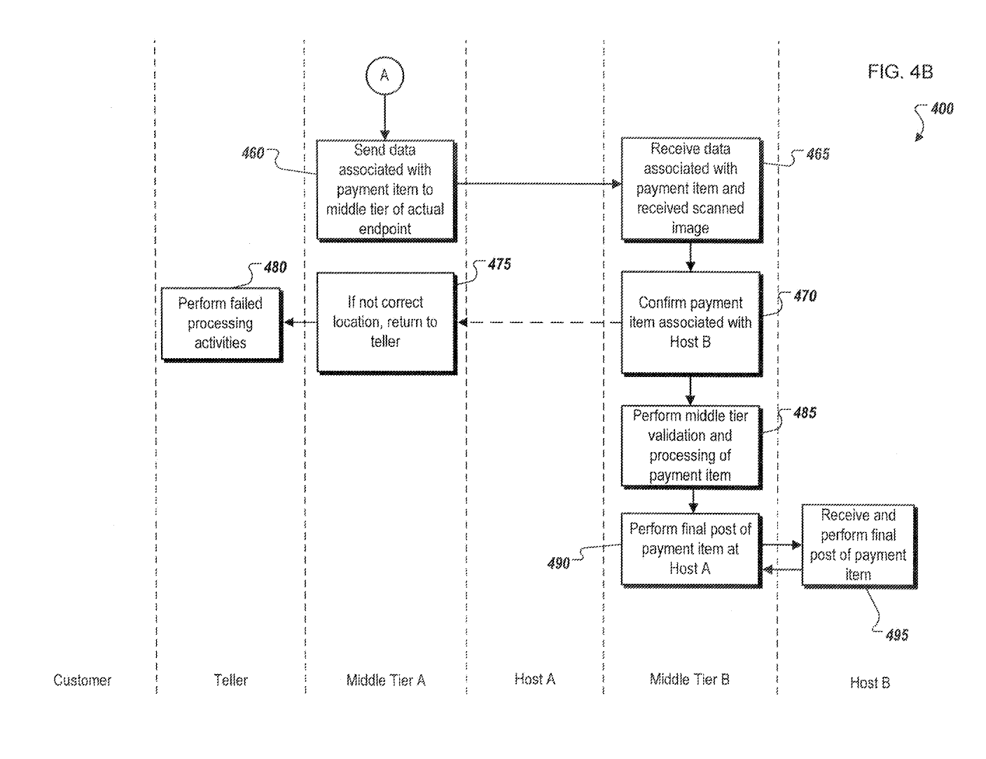

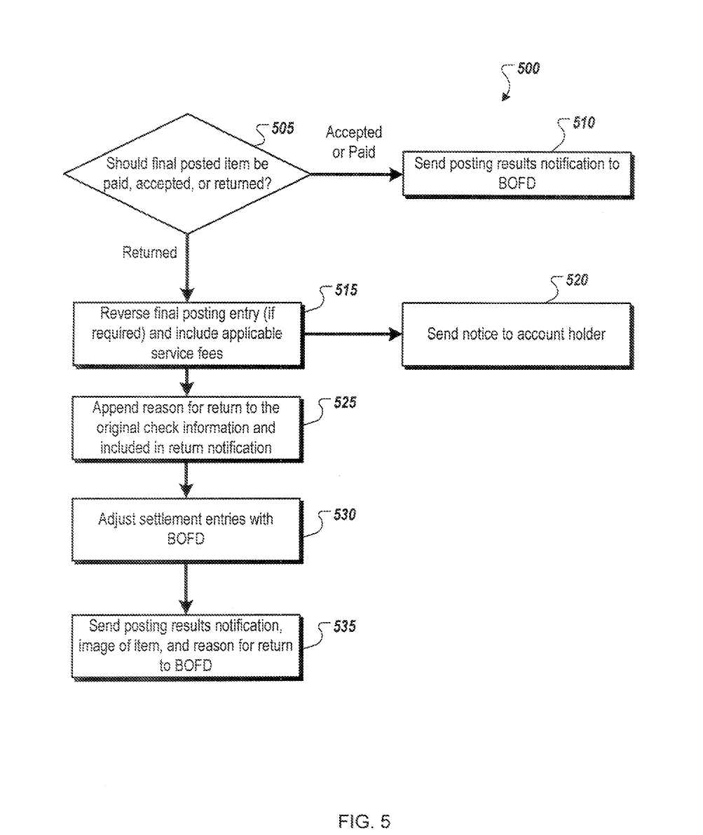

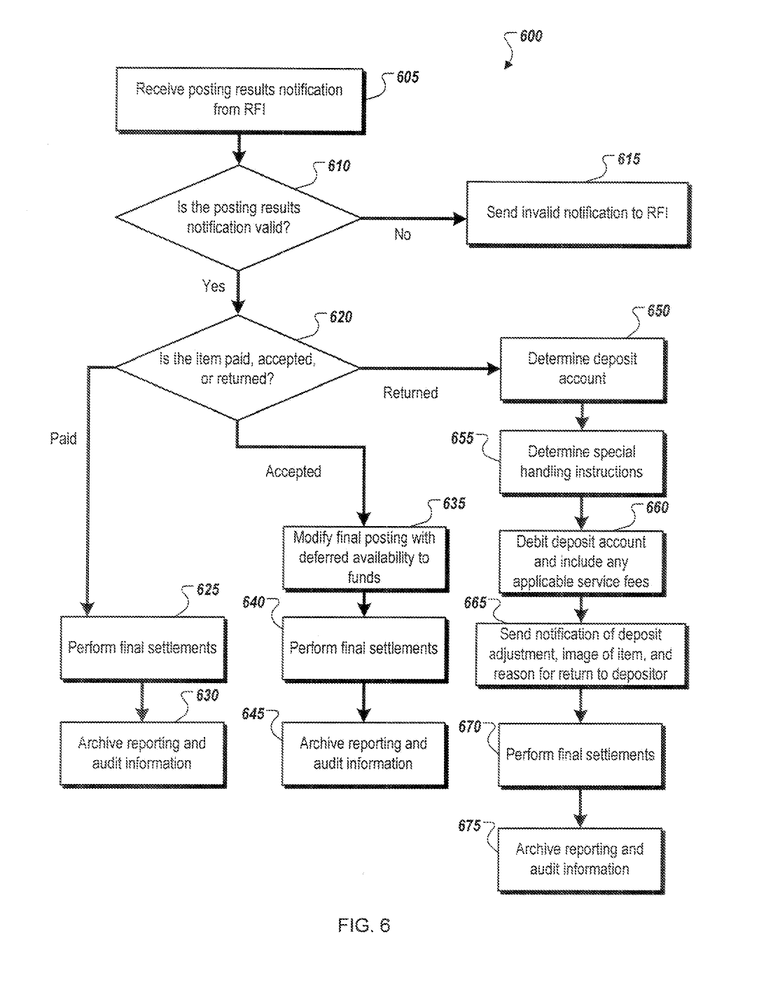

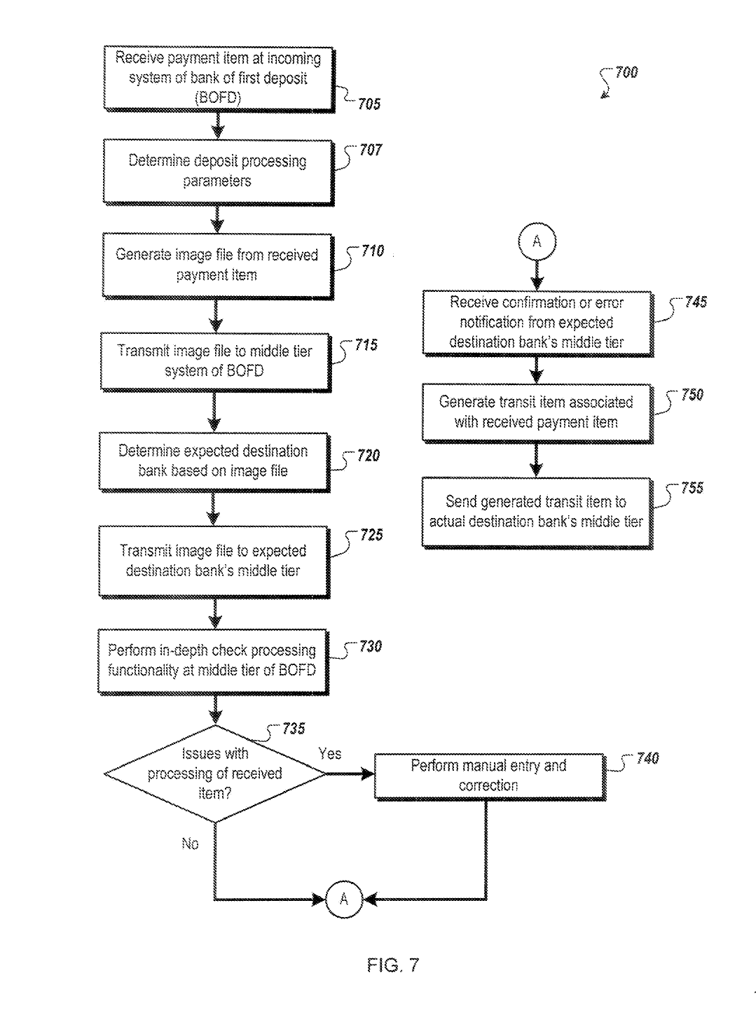

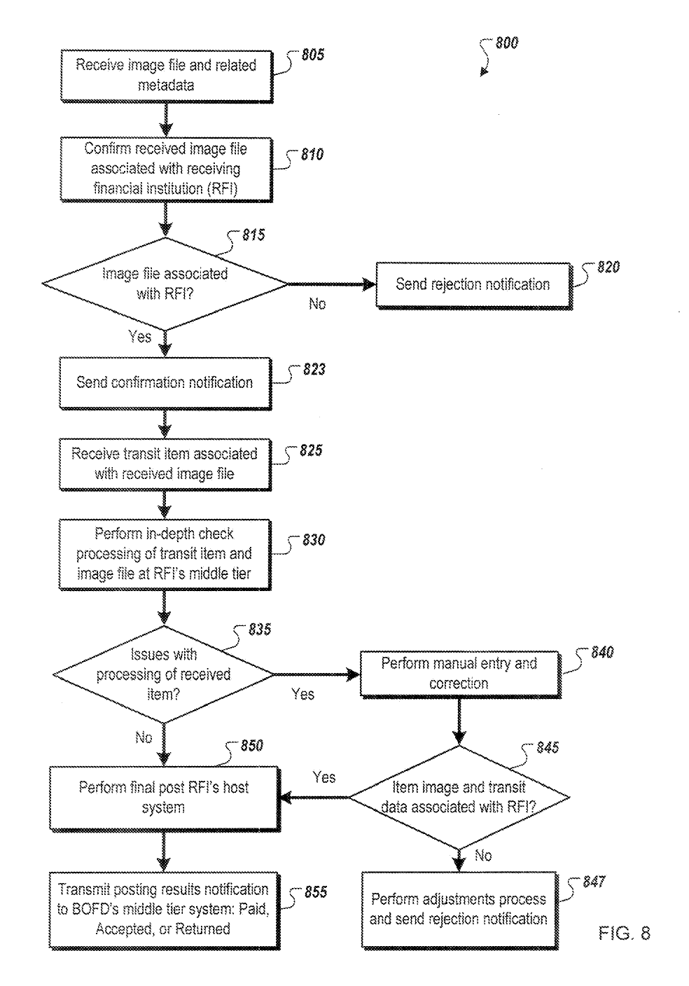

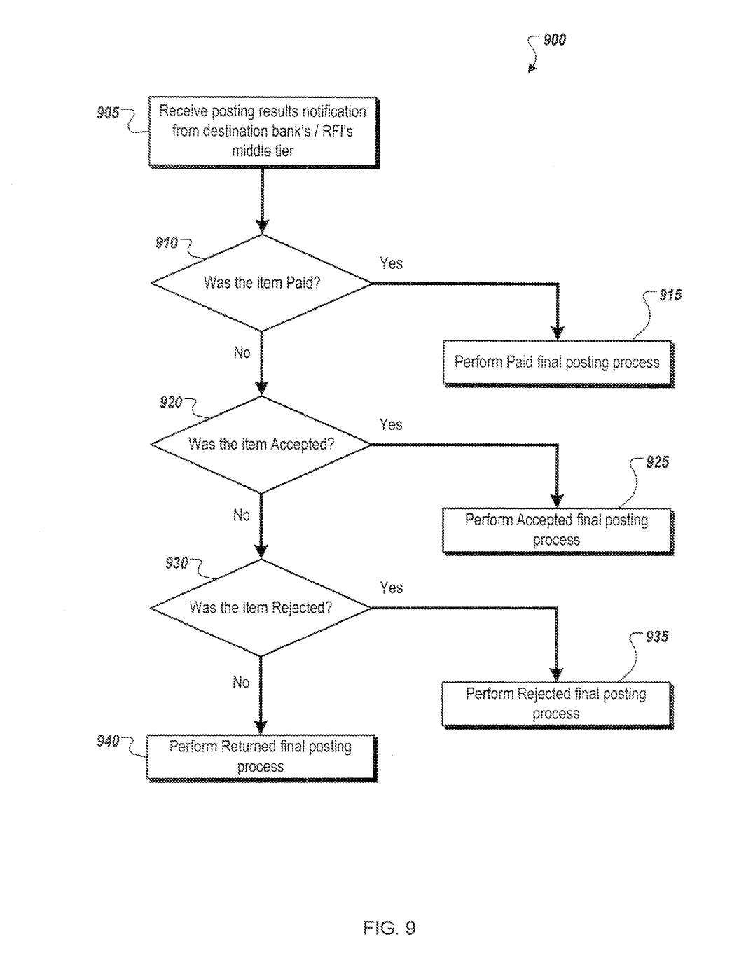

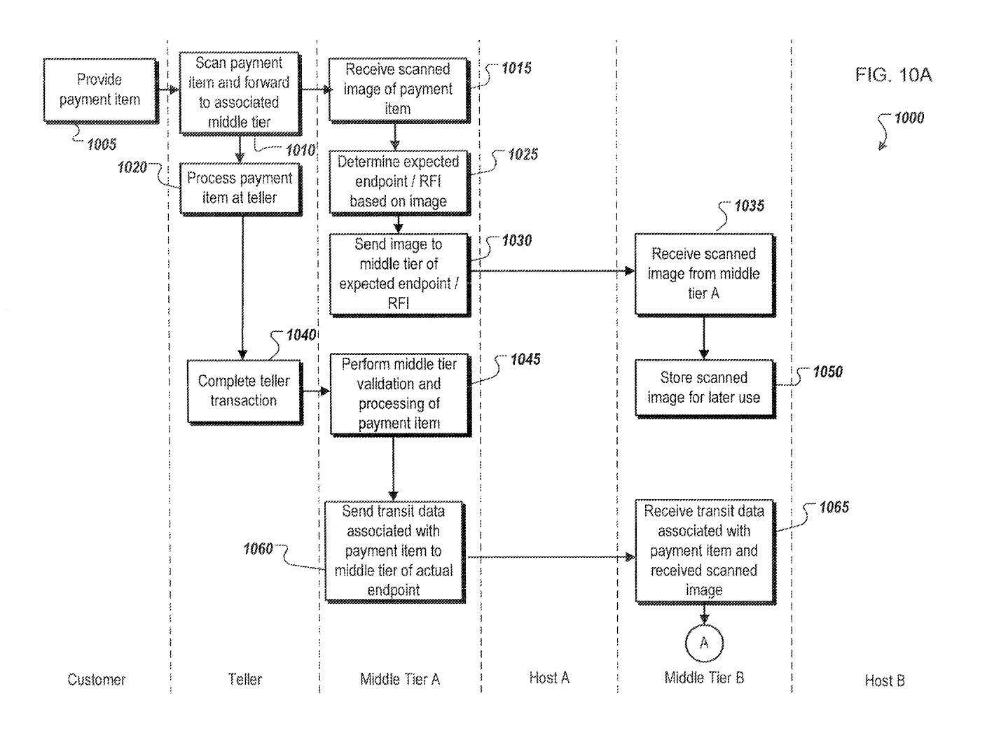

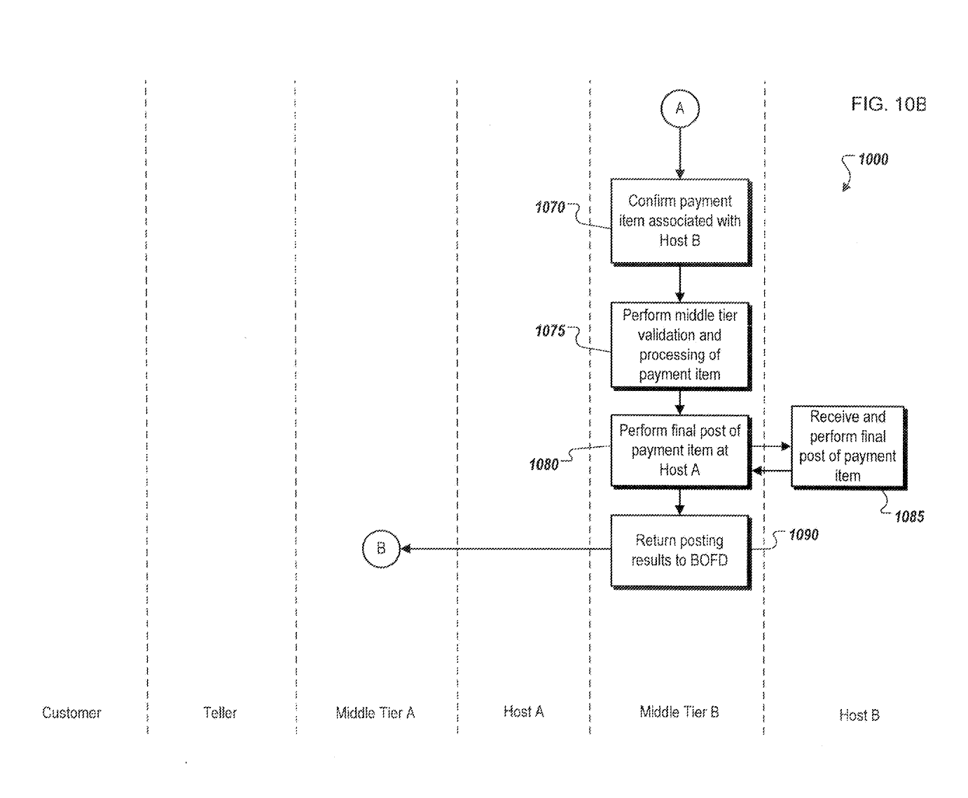

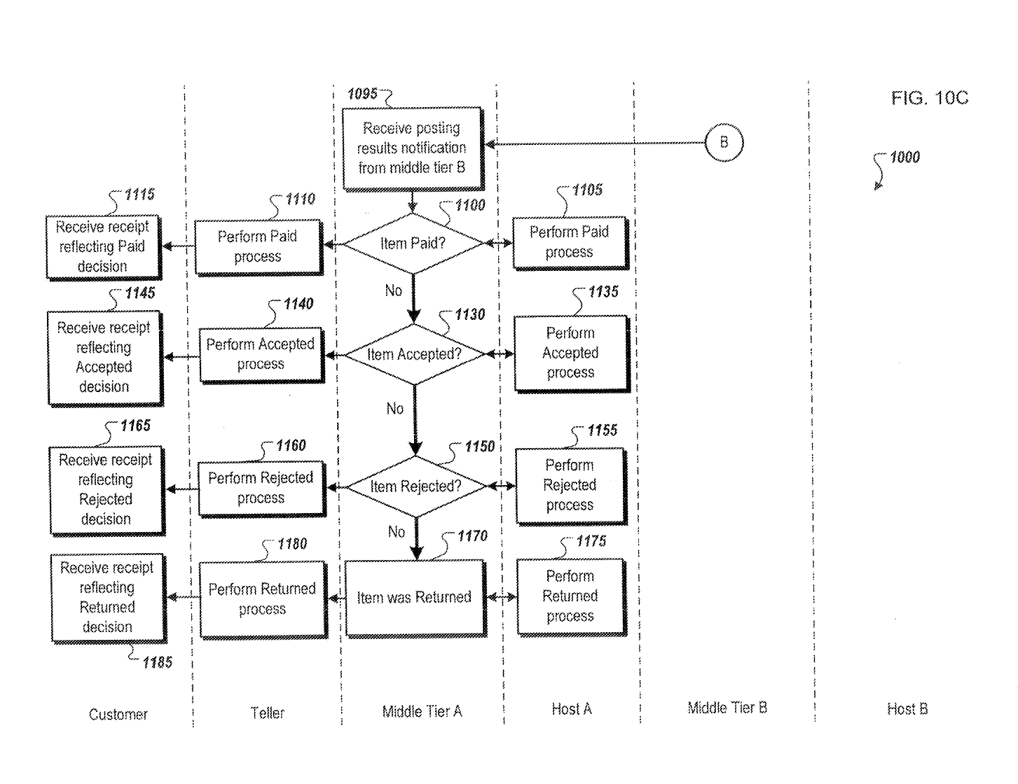

FIG. 1 is described using the real-time and/or online straight-through forward presentment process further described in FIG. 2, FIG. 3, FIG. 4A and FIG. 4B. Nevertheless, FIG. 1 (system 100) is equally applicable to the additional real-time and/or online straight-through forward presentment and return presentment processes described in FIG. 5, FIG. 6, FIG. 7, FIG. 8, FIG. 9, and FIG. 10, as well as other alternative implementations.

FIG. 2 is a flowchart illustrating an example method 200 for performing real-time and/or online straight-through processing for forward presentment of a check or electronic payment item from the perspective of the BOFD. For clarity of presentation, the description of method 200 that follows references environment 100 illustrated in FIG. 1 for elements that may perform one or more of the described operations. However, it will be understood that method 200 may be performed, for example, by any other suitable system, environment, or combination of systems and environments, as appropriate.

At 205, a check or payment item is received at a receiving, or incoming, system of the bank of first deposit (BOFD). The incoming system of the BOFD may include, among others, a teller workstation in a BOFD branch location, a merchant-based capture system used to capture and deposit check and payment items remotely at a merchant or retailer, or a consumer-based application where checks and other payment items can be deposited online through a web-based portal or application. Upon receiving the check or payment item, an image file containing scanned images or snapshots of the received check or payment item is generated at 210. In some instances, the image file may be generated using a traditional flatbed scanner, a digital camera (including cameras included on smartphones and other devices), or through other suitable means. In many instances, the image file may include an image of the front and back of the check or payment item, as well as a capture of the MICR line data.

At 215, the image file is transmitted from the incoming system of the middle tier system of the BOFD. The length and type of transmission at 215 depends on the incoming system at which the check or payment item was received, as well as the location of the BOFD's middle tier system. In the scenario where the payment item is received at a teller location, the transmission of the image file to the BOFD may be a submission of the image file to a back-end system located at the BOFD, or to a system connected to the middle tier system by a VPN or internal network within the BOFD's information technology systems. If, alternatively, the incoming system where the check or payment item was received is remote from the BOFD (i.e., at a merchant capture device or a consumer capture device), then the image file may be packaged and sent via the Internet, a private connection, or other suitable type of network to the BOFD's middle tier system. In general, communications of the image file may be encrypted to maintain security of the check or payment item information during transmission.

At 220, the middle tier system (or alternatively, a component thereof, an external component, or an application associated with the generation of the image file) determines an expected receiving (payor/endpoint) bank based on the image file. Additionally, information received or entered at the incoming system of the BOFD may also be used to determine the expected receiving bank (payor/endpoint) of the image file (and therefore, the check or payment item itself). In one example, the image file may be processed using optical character recognition (OCR) and the initial scan of the MICR line may be decoded to determine the likely or expected receiving (payor/endpoint) bank of the image file and associated payment item. In other instances explicit information captured at the incoming system, such as manually keyed entries, may be used to determine the expected receiving (payor/endpoint) bank of the image file and the payment item. At 225, the image file is transmitted to the receiving (payor/endpoint) bank's (or financial institution's) middle tier system. As illustrated in FIG. 1, any number of middle tier systems may be connected to each other through a suitable, and in some cases, secured and/or encrypted, network connection or connections. Using these connections, the middle tier of the BOFD can direct an electronic transmission of the generated image file to the expected receiving (payor/endpoint) bank's middle tier. As illustrated, the generated image file is sent prior to any additional processing and validation of the image file (other than determining the expected receiving (payor/endpoint) bank). In sending the generated image file at this time, the usual time delay associated with sending image files to the receiving (payor/endpoint) bank is generally avoided, as the image files can be effectively streamed to their expected receiving (payor/endpoint) banks while the local BOFD processing and validation processes are performed. Once those validation and processing steps are completed, the data associated with those steps is sent to the receiving (payor/endpoint) bank, where the information and image file are associated and combined, and additional processing at the receiving (payor/endpoint) bank is performed.

Returning to FIG. 2, at 235 the middle tier system at the BOFD performs the in-depth processing operations associated with check processing and validation. These operations include any number of steps and validations, including, for example, MICR codeline verification, image quality analysis, amount keying, fraud detection, and suspect review, among others. Generally, the middle tier analysis confirms the information received at the teller (or incoming system), as well as the image file quality, and uses that information to finalize a transaction associated with the received payment item. In most instances, the middle tier operations require little to no human interaction to perform the required processes and create the associated transactions. In some cases, however, issues may arise that require manual intervention to complete the process. At 240, the system performing method 200 determines whether any issues arose with regard to the processing or validation of the received payment item. If no issues were encountered, method 200 continues at 245, where the system performs a final post of the transaction at the BOFD's host system. The final post includes modifications to any associated customer accounts, including crediting or debiting customer accounts as necessary. Because most transactions do not require manual intervention due to processing and validation issues, many transactions can be completed in real-time (or near real-time) as a customer interacts with the incoming system or teller. In those instances, the customer may receive, at the end of the interactions, a receipt indicating the completion of the transaction and account information accurately reflecting the current status of the customer's account.

If, however, issues arose during the validation and processing operations, method 200 continues at 250, where the middle tier system of the BOFD performs a memo post at the BOFD's host system. The memo post reflects a temporary entry in the customer's account that may be changed or updated prior to completion, or the final post. In prior systems, the memo post was generally used prior to the completion of a batch process finalizing a set of financial transactions. In the currently described system, the memo post may be limited to uses when the in-line processing of a transaction is delayed, realizing a much higher percentage of final posts than memo posts when the system is practiced. At 255, manual entries, corrections, and reviews of the transaction, image file, and associated data are performed. These manual steps may be performed by individuals or representatives local to the middle tier system in some instance, or by remotely located employees or contractors in other instances. Once the manual processes are completed, at 260 the information is submitted to the middle tier, confirmed, and the memo post in the customer's account is converted to a final post. The transaction is then finalized at the BOFD, and method 200 continues at 265.

At 265, a transit item associated with the received check or payment item is generated. Generally, transit items may be used to send transaction information to the receiving financial institution associated with the received check or electronic payment item. Each check or electronic payment item may have its own transit item generated, the transit item including information describing credits or debits to be applied to the receiving financial institution's customer or internal accounts. In some instances, these transit items may be called “on others items,” indicating that the check or electronic payment item is drawn on another financial institution. In some instances, the check or payment item received at 205 may be provided by the BOFD's customer, as well as drawn on the BOFD itself (an “on-us item”). In these instances, all processing may be performed in-house at the BOFD, with the BOFD's host system performing the necessary transactions to accurately reflect the account changes related to the transaction. As illustrated in FIG. 2, however, the received check or payment item is not drawn on the BOFD, and therefore is sent as a transit item to the receiving (payor/endpoint) bank at 270. During the in-depth processing steps of 235, the middle tier of the BOFD determines the actual receiving (payor/endpoint) bank of the check or payment item, including a comparison as to whether the expected receiving bank (payor/endpoint) determined at 220 is the same as the actual receiving (payor/endpoint) bank. In most cases, the two will match, and the previously-transmitted image file will already have arrived at the actual receiving (payor/endpoint) bank. In those cases, the transit item may not include the image file, and may instead include a unique identifier that can be used by the actual receiving (payor/endpoint) bank to match the previously-received image file with the transit item (sent at 225). If, however, the actual receiving (payor/endpoint) bank and the expected receiving (payor/endpoint) bank do not match, the corresponding image file is resent to the actual receiving (payor/endpoint) bank with, or included in, the transit item. Alternatively, the BOFD and receiving (payor/endpoint) bank may choose to send the image and transit item data in a single transmission thereby bypassing the initial transmission of the image file in 225.

FIG. 3 is a flowchart illustrating an example method 300 for performing real-time and/or online straight-through processing for forward presentment of a check or other electronic payment item from the perspective of a receiving (payor/endpoint) bank or financial institution (RFI) associated with a check or payment item received at a BOFD. Method 300 may be performed by any suitable system, but for clarity of presentation, the description that follows uses system 100 of FIG. 1 as a particular example for describing the method steps. However, another suitable system or combination of systems may be used to perform method 300 in alternative implementations.

At 305, the RFI receives an image file (and, in some cases, metadata or other information associated with the image file). Generally, the RFI receives the image file from an associated middle tier system associated with a BOFD (or another financial institution from which payment items can be received for processing). The image file is generally received at the RFI's corresponding middle tier system via a network or other communication means over which information is shared or exchanged between the financial institutions. The image file will generally include a unique identifier that can be used to later connect or associate additional information and transaction data with the received image file. In general, the image file may include an image of the front and/or back of a check or other payment item, as well as an image or other information associated with the MICR line of the payment item. In some instances, the received image file can be stored in a local image repository until additional information is received from the BOFD. At 310, the RFI's middle tier can review the image file and any associated metadata received with the image file to confirm that the image file is associated with and meant for the RFI. At 315, the middle tier determines whether the image file is associated with the RFI. If the image file has incorrectly been sent to the RFI, method 300 continues at 320, where the RFI can return a notification to the originating financial institution (here, the BOFD) to notify that institution of the error. Alternatively, the RFI can ignore and disregard the image file. In most cases, incorrect image files will not receive additional data, as the in-depth processing at the originating financial institution will generally identify the error before additional information is transmitted to the RFI. If additional information is received for an image file that is not associated with the RFI, the RFI may then provide an error or other notification to the originating financial institution.

If, however, the image file is associated with the RFI, method 300 continues at 325, where a transit item associated with the received image file is received. The time between receiving the image file and receiving the transit item may vary in different situations (e.g., when additional processing and validation is required at the BOFD). In some instances, the transit item is received at the RFI only after the BOFD completes and finalizes its processing, validation, and posting of the corresponding transaction. In any event, the transit item is received at 325. The association of the transit item with the received image file may be performed based on identical, matching, or related unique identifiers associated with both the received image file and the received transit item. For example, the RFI's middle tier may perform comparisons of the received transit item's identifier with those of a plurality of stored image files prior to properly associating the two files. Alternatively, the BOFD and RFI may have agreed to transmit both the image file and transit data in a single transmission.

Once the received transit item is associated with the correct image file, the RFI's middle tier performs an in-depth processing of the transit item and image file at 330. As with the BOFD in method 200, the in-depth processing operations of 330 may include processing and validation operations including, for example, MICR codeline verification, image quality analysis, amount keying, fraud detection, and suspect review, among others. In some instances, the processing and validation operations may be identical for both the BOFD's middle tier and the RFI's middle tier. In other instances, the validation and processing operations of the RFI may include additional or fewer operations than the similar process at the BOFD, as well as performing the various operations in a different order than the BOFD. In some instances, the BOFD's middle tier may supply the RFI's middle tier with information regarding the validation and processing operations and results performed at the BOFD. In some instances, and based on the received information on the BOFD middle tier's analysis, the RFI may accept certain validation or processing operations as completed or unnecessary at the RFI's middle tier (e.g., the image quality analysis operations). In other instances, the RFI's middle tier may perform the standard validation and processing operations regardless of the results returned at the BOFD.

At 335, the RFI's middle tier system determines whether any issues arose during the processing of the received transit item and image file. If no issues arose, method 300 continues at 340, where the RFI middle tier submits the transaction information to the RFI's host system, where the associated customer's account information is updated using a final post. Alternatively, if issues were encountered during processing and validation, method 300 continues at 345, where the RFI's middle tier system requests the RFI's host system to perform a memo post. At 350, any manual review, corrections, and/or entries may be performed by users associated with the RFI's middle tier. Upon completion of the additional manual processing, the RFI's middle tier requests and/or causes the RFI host system to convert the memo post into a final post at 355.

FIG. 4 is an example signaling and flow diagram illustrating operations associated with performing real-time and/or online straight-through processing for forward presentment of a check or other electronic payment item. Specifically, the system of FIG. 4 illustrates operations across a customer, a teller (or teller-equivalent), a middle tier system and a host system associated with a BOFD (middle tier A and host system A), and a middle tier system and a host system associated with an RFI (middle tier B and host system B). Although certain operations are illustrated as associated with or performed by a particular element, any suitable combination of illustrated or non-illustrated elements and operations or processes may be used to perform the steps and operations described.

At box 405, a customer provides a check or payment item to a bank of first deposit (BOFD). As illustrated in the example of FIG. 4, the provision of the check or payment item is provided to a teller At box 410, the payment item is scanned (or otherwise captured so that an image file of the payment item is generated), with the scanned image file being sent to the middle tier A associated with the teller. Simultaneously with the image file being sent to the middle tier A, the teller performs a set of initial processing of the check or payment item at the teller in box 420. In some instances this may include the teller adding customer-specific information along with the payment item, such as a customer account number, a driver's license number, and other related operations.

Returning to box 415, middle tier A receives the scanned image file associated with the payment item. At box 425, middle tier A determines an expected receiving (payor/endpoint) bank for the check or payment item based on the scanned image file (or alternatively, any information included or transmitted with the image file, including data entered by the teller). Once the expected receiving (payor/endpoint) bank is determined, at box 430 middle tier A forwards the image file (containing at least the image file and a unique identifier for associating additional, related information) to middle tier B of the second system, where at box 435 middle tier B receives the image file from middle tier A. Middle tier B stores the scanned image file and associated unique identifier in local (or remote) storage for later use and association with finalized transit items at box 437. By sending the image file prior to the processing steps at the middle tier A, the present system allows for immediate presentment at middle tier B once the check or electronic payment item is received. Additionally, the transmission of the image file from one middle tier to another generally constitutes a majority of the data exchanged between financial institutions. By performing this time- and data-intensive task early in the operations, and specifically while various other operations are being performed at the BOFD's middle tier A, the time required to clear and finalize transactions throughout the system is greatly reduced. The transmission of image files and other data between the respective middle tiers may be performed over any appropriate communication protocols and/or channels, including a VPN between the systems, a dedicated network connection, or encrypted communication over the Internet, among others.

At box 440, the teller transaction (or teller-equivalent transaction, such as a merchant capture transaction or consumer device-based transaction) is completed, or at least the initial teller processing of the check or payment item is completed. The scanned image file and the results of the teller processing are provided to middle tier A of the BOFD, where at box 445 the middle tier performs the various middle tier validations and processing operations on the payment item and image file, including an image quality analysis, a MICR codeline confirmation, and other related processes. Once the middle tier processing and validation of the payment item is complete, the middle tier A requests a final post of the payment item transaction information at host system A at box 450. At box 455, the host system A receives the final post request, and assuming all criteria are met, performs the final post of the payment item transaction to the related customer accounts.

Once the final post of the transaction is completed at box 455, the host system A can provide the middle tier A with a confirmation that the transaction has posted. At box 456, the middle tier A confirms the final post of the transaction with the teller and/or the teller-equivalent. At 457, the teller (or teller-equivalent) prepares a receipt for the customer reflecting the status of the final post of the transaction in financial institution A's system, and at 458 the customer receives the prepared receipt reflecting the final post. In previous systems, this was unavailable, as the check processing and validation steps were performed outside of the middle tier and in a separate and distinct process, usually taking at least until the end of the current business day to complete.

At box 460, middle tier A sends data associated with the finalized transaction of the payment item (at the BOFD) to the middle tier of the actual receiving (payor/endpoint) financial institution. As described in FIGS. 2 and 3, the actual receiving (payor/endpoint) bank will generally be the same as the expected receiving (payor/endpoint) bank, but the actual receiving (payor/endpoint) bank is the confirmed receiving (payor/endpoint) bank based on the processing performed at the middle tier A. Further, the data associated with the final transaction and posting of the payment item may be included in a newly-generated transit item, including the information relevant to the posted transaction, including any debits or credits due from or to the RFI associated with middle tier B and host system B. At box 465, middle tier B receives the transit file or other data associated with the payment item and the previously received image file, and further, may associate the transit file (or other data) with the scanned image file stored by the middle tier at box 437. Once associated, middle tier B can confirm whether the payment item associated with both the received transit item and image file are associated with an account or accounts managed or stored by host system B at box 470. If middle tier B determines that the payment item was erroneously received, a notification may be returned to middle tier A, and middle tier A may handle any internal corrections at box 475, such as by providing the erroneous information to a teller for manual correction at box 480.

If, however, the image file and the transit item are associated with information located at host system B, then at box 485, middle tier B can perform the associated processing and validation of the transit item and image file. Once the processing and validation operations are complete, middle tier B can request that a final post of transaction data associated with the received transit data and image file be performed at the host system B (as illustrated in box 490). That request is sent to host system B, and at box 495, the host system B performs the final post of the transaction associated with the image file and transit item corresponding to the payment item provided by the customer at box 405.

FIGS. 5 and 6 illustrate processes performed at or associated with the RFI (method 500) and the BOFD (method 600) for performing an online straight-through process for returns presentment through interactions of the respective middle tiers of the RFI and BOFD. Specifically, FIG. 5 illustrates an additional set of example operations performed at the RFI after the example operations illustrated in FIG. 3 (operations 340 and/or 355). FIG. 6 illustrates an additional set of example operations performed at the BOFD in response to the operations performed at the RFI in FIG. 5. In general, the operations of the RFI are modified to implement a real-time and/or online posting and returns process (or emulation of a real-time posting process through memo-posting), and the operations of the BOFD are modified to receive individual posting results notifications online from the middle tier and take appropriate actions based upon the information in the notification. Settlement in the illustrated methods 500 and 600 is based upon the processing of individual items, although intra-bank and inter-bank settlement may be performed in an aggregated manner in suitable circumstances. Methods 500 and 600 may be performed by any suitable system, but for clarity of presentation, the description that follows uses system 100 of FIG. 1 as a particular example for describing the method steps. Additionally, the operations may be performed or associated with any suitable presentation operations, and are not limited to those described in FIGS. 3 and 4. Another suitable system or combination of systems may be used to perform methods 500 and 600 in alternative implementations.

The operations of FIGS. 5 and 6 are associated with a set of assumptions, regardless of whether methods 500 and 600 are performed after or in connection with the illustrated operations of FIG. 3 or others. First, an assumption is made that the depositor (at the BOFD) has completed the initial deposit process with the BOFD. For example, the depositor, after submitting one or more checks or other payment items, may have received a receipt from the BOFD for the prior transaction. Additionally, the check or payment item at issue will have been presented online from the BOFD to the RFI through the respective middle tiers of both institutions. A set of “posting results information” is communicated online from the RFI to the BOFD through the respective middle tiers of both institutions. Additionally, the BOFD processes the posting results information after the initial deposit process has been completed, such that the returns process described herein may be considered to be performed online, but not in real-time (i.e., during the transaction and prior to the completion of the initial deposit process of the depositor with the BOFD). Finally, “rejected” checks or electronic payment items (or adjustments) are not included in the illustrated operations, although a person of ordinary skill in the art would understand and appreciate implementations where handling rejected checks due to, for example, the check image and/or related data not being accepted by the RFI for final posting and processing are encountered. In the illustrated examples, the possible check dispositions are therefore “Accepted”, “Paid”, or Returned”.

Benefits from the processes illustrated in FIGS. 5 and 6 include the following. First, the illustrated online returns process provides support to the real-time posting implementations illustrated in the prior figures, and allows the online, straight-through forward presentment and posting process to be complemented by the described returns presentment process. The separate transmission of (1) the image of the check and (2) the additional data regarding the check results in a reduction in the telecommunications cost versus the existing batch and bulk data transmission processes currently performed by financial institutions. As described above, another benefit is that the forward presentment and posting of checks and electronic payment items, as well as the returns presentment process, can be completed in the first day, as opposed to the existing process operations that occur into the second or third day from the original deposit.

In general, FIGS. 5 and 6 (and their respective methods 500 and 600) describe the online returns presentment process from the separate perspectives of the RFI and the BOFD, respectively. In FIG. 5, a posting decision is made by the RFI (i.e., whether the check or electronic payment item is to be honored), with that posting information being provided to and processed by the BOFD in FIG. 6. In general, the process is limited to checks and electronic payment items using the online straight-through processing forward presentment process from the BOFD to the RFI described above. In some situations, the BOFD and the RFI may be the same financial institution or bank, such as when the depositor and the check or payment item's maker are account holders of the same bank. In those instances, the communications between the different middle tiers may be unnecessary, with all communications being performed internally within the one institution. As described above, the process is described for settlements on a “single check or payment item” basis, although settlement may also be used on an “aggregated checks or payment items” basis. The aggregated settlement could be performed and/or based upon preset parameters to determine the appropriate aggregation, including defined time parameters, volume thresholds, dollar amounts, or other appropriate parameters. Additionally, the illustrated audit reporting and information archiving are described on a “single check or payment item” basis, although similar to the settlements, the audit reporting and information archiving can be performed on an “aggregated checks or payment items” basis according to one or more predefined parameters.

Method 500 of FIG. 5 begins at 505. In some instances, 505 may occur after operations 340 and/or 355 of method 300, such as when a final post is to be performed at the RFI's host system. Alternatively, method 500 may occur prior to the attempted final post at the RFI, including after the in-depth check processing performed at 330 in method 300, as well as at any other suitable time. Further, method 500 may be performed concurrently with or in parallel to one or more of the operations in FIG. 3. At 505, the RFI determines if the check or other payment item posted is to be “Accepted”, “Paid”, or “Returned”. A check or payment item designated as “Accepted” by the RFI can mean that the RFI does not expect to return the check in the future, although the RFI retains the right to do so. The designation of “Accepted” may be provided when a final post at the RFI cannot be completed, or when additional processing and operations may be performed at the RFI. A check or payment item designated as “Paid” by the RFI means that the RFI will not return the item in the future. An item designated “Returned” is not accepted by the RFI, and the RFI will not credit the BOFD for the item. Examples of items that may be designated “Returned” and not accepted by the RFI include, but are not limited to, items drawn on accounts with insufficient funds, items drawn on accounts with uncollected funds, checks associated with stop payment requests, items drawn on closed or dormant accounts, and positive pay errors. The RFI's determination as to which designation(s) to apply may be based on any suitable processing method, including methods that occur before, after, and/or during final posting. The example of FIGS. 5 and 6 illustrates the processes being performed after the final posting. In other instances, the processes could also perform the determination as part of the in-depth analysis described in operation 330 of FIG. 3.

If the check or payment item is determined to be “Accepted” or “Paid”, a posting results notification is sent from the middle tier of the RFI to the middle tier of the BOFD at 510. In some instances, no further processing may be required or performed. Alternatively, if the check is determined to be “Returned” by the RFI for any reason, method 500 continues at 515. First, the final posting entry (illustrated at 340 and 355 of FIG. 3) at the RFI is reversed at 515 if required, with the RFI assessing any applicable service fees to the account holder (maker) of the returned check or payment item. Two operations are then illustrated as occurring after 515. First, the RFI prepares and sends a notification to the account holder (maker) of the returned item at 520. The notification can be in any appropriate form, including a paper notification, an electronic notification, or both. Second, at 525, the reason for the return is appended to the original check or electronic payment item information and included in a posting results notification to be sent back to the BOFD. The original check or electronic payment item information may be updated, or additional information appended thereto, to indicate that the check or electronic payment item is “Returned”. For example, a new or updated unique ID or a variation of the prior unique ID may be generated to identify the payment item as “Returned”. Alternatively, a data field associated with the payment item's status may be updated to reflect the “Returned” status. The image of the original check or payment item may be included in, associated with, or referenced by the original check or electronic payment item information.

At 530, adjusting settlement entries are created to modify the intra-bank and inter-bank accounts associated with the attempted transaction. For example, the inter-bank accounting may be adjusted as appropriate due to the returned check or electronic payment item, reversing or cancelling prior transactions associated with the payment item. At 535, the posting results notification can be sent from the RFI to the BOFD through the respective middle tiers of the RFI and the BOFD. The posting results notification can include the original unique sequence number or other unique ID associated with the original check item, the image of the returned item, the reason for the return, and any other suitable information, including updated payment item fields or newly generated/updated IDs associated with the returned item.

Method 600 of FIG. 6 illustrates the online deposit completion process performed at and/or by the BOFD corresponding to method 500 of FIG. 6 that is performed at the RFI. Method 600 starts at 605, when a posting results notification is received at the BOFD from the RFI via the middle tier. In the illustrated example, the posting results notification received at 605 is the same as the posting results notification sent at 535 (or 510 where the final posted item is “Accepted” or “Paid”) of FIG. 5. At 610, the BOFD confirms whether the received posting results notification is valid. Validation of the posting results notification may be performed by any suitable operations. In some instances, validation may be based on whether the posting results notification corresponds to an item previously sent to the RFI by the BOFD. If the notification is not valid, method 600 continues at 615 where an invalid posting results notification is generated and sent to the RFI via the respective middle tiers. The BOFD may not perform additional processing where the posting results notification is not validated. If, however, the posting results notification is determined to be valid, method 600 continues to 620.

At 620, the BOFD determines whether the item was “Paid”, “Accepted”, or “Returned”. If the check or electronic payment item is determined from the posting results notification to be “Paid”, no change is required to the prior final deposit posting since the item funds are available from the RFI. Any required final settlement entries are created and performed at 625 (e.g., inter-bank settlement transactions), and at 630 audit reports are produced and audit information is archived as required by law and/or as defined by the internal processes of the BOFD. If, instead, the payment item or check is determined to be “Accepted”, method 600 continues at 635. The prior deposit's final posting can be modified at 635 to defer depositor availability and access to the item's funds according to the standards established by the BOFD. Any required final settlement entries are created and performed at 640 (e.g., inter-bank settlement transactions), and at 645 audit reports are produced and audit information is archived as required by law and/or as defined by the internal processes of the BOFD.

If, however, the check or electronic payment item is determined to be “Returned” at 620, method 600 continues at 650. At 650, the original depositing account is determined. The determination of 650 may be performed in any suitable manner or using any suitable method, including a search of prior deposit records matching an identifier or field of the returned payment item to an account at the BOFD or searching one or more databases of deposited items and item information within the BOFD's database for parameters matching the returned item, among others. At 655, any special handling instructions for the depositing account are determined. In one instance, special handling instructions for a particular depositor may include requests to debit or credit a single central account for items associated with different locations of a particular business. Other types of special handling instructions and methods of determined said special handling instructions are suitable for use with method 600. Based upon the information determined for the depositing account, as well as any special handling instructions, the depositing account is adjusted by the amount of the check or electronic payment item at 660. The adjustment may be made directly to the depositing account or to related accounts as directed by the special handling instructions. In some instances, the BOFD may assess any appropriate service fees associated with the returned item. At 665, appropriate return notifications are prepared for and sent to the depositor. In some instances, the notifications may be made directly to the depositing account or its designated contact person or entity, while the special handling instructions may request notice to a particular representative or entity. The notifications may be in any appropriate format (i.e., paper and/or electronic notices), and may include images of the associated check or payment item with return information (including the deposit adjustment) and the reason for the return. At 670, any appropriate and/or required final settlement entries are performed (e.g., intra-bank and inter-bank settlement transactions). At 675, audit reports are produced and audit information is archived as required by law and/or as defined by the internal processes of the BOFD.

FIGS. 7-10 illustrate an alternative implementation of a real-time and/or online straight-through process for a forward presentment and returns presentment system as implemented at a BOFD and an RFI associated with the illustrated environment 100 (or a derivation thereof). For purposes of this document, the processes illustrated in FIGS. 7-10 represent an integrated check or electronic item process that can be used alternatively or in combination with the forward presentment, processing, and return presentment processes illustrated and described in connection with FIGS. 2-6. The processes described in FIGS. 7-10 leverage the architecture of the middle tiers associated with the BOFD and RFI described herein, and extend the system in order to integrate the forward presentment and return presentment processes into a single process starting and ending at the initial point of deposit (e.g., the teller of the BOFD, a merchant capture device/system associated with the BOFD, a consumer capture device, an ATM, etc.).

The integrated system and processes described in FIGS. 7-10 are associated with several assumptions. First, the processes will be completed online and starting and ending in real-time at the initial deposit point, although the process may be completed in an online manner if the process cannot be completed in real-time. For example, if the time to complete the process exceeds a predetermined deposit time out value, the overall process may move forward on a memo posting basis so that the customer or depositor can continue and finalize the transaction without an undue delay. All remaining processes may then be performed in a non-real-time (or online) manner to their completion. Generally, the customer or depositor will be actively engaged with the BOFD at the initial deposit point or incoming system throughout the process, allowing a deposit to be completed at the initial deposit point or incoming system. When run in “notification-only” mode, this can allow a returned check or other electronic payment item to be eliminated at the initial deposit point or incoming system prior to entering the settlement process, thereby avoiding the costs associated with processing and then returning the item. The initial deposit point and its associated system may establish a deposit time limit to define the amount of time allowed for a deposit to complete in real-time. In some instances, the length of the deposit time limit may be dynamically determined based on the type of interaction being performed. For example, an ATM deposit or a merchant capture device deposit may have a different deposit time limit as compared to a teller deposit or a customer capture device deposit. Additionally, the type of depositor account may be used to determine the deposit time limit as well (i.e., a commercial depositor or a personal depositor). Other suitable factors may also be used to determine the deposit time limit.

The integrated system may further include operations for adjustments. Adjustments may occur when the check or electronic payment item is rejected by the RFI based on the quality of the image or the image's associated data. A deposited check or payment item may be designated as an “on-us” item, an “in network” item, or an “out of network” item. For an “on-us” item, the maker of the check or payment item is also an account holder at the BOFD, such that the BOFD is the same as the RFI. For an “in network” item, the maker of the check or payment item is an account holder at an RFI that is connected to the BOFD through the middle tiers. For an “out of network” item, the maker of the check or payment item is an account holder at a RFI that is not connected to the BOFD through the middle tiers. “Out of network” items may be processed through traditional check collection channels as opposed to those described herein. Further, “on-us” items may be processed internally through the BOFD, and/or through processes analogous to those described herein, but without the need to send the data and images to a different financial institution.

Generally, the process for completing the real-time processing, presentment, and return operations described in FIGS. 7-10 is invoked by the initiating deposit point or system, with the processing, forward presentment, and return presentment operations occurring between the BOFD and RFI. To be completed in real-time, the deposit time limit identified upon invocation will not be exceeded, and the check or payment item will be determined to be one of “Accepted”, “Paid”, or “Returned” by the RFI upon receipt. If the check or payment item is determined to be “Rejected” by the RFI alternative operations may be performed as appropriate. The processes may be managed by the workflow management component at the BOFD's middle tier (workflow management component 126a) described in FIG. 1, with the workflow management component monitoring the deposit processing parameters, deposit time limit and the individual process step time boundaries. For example, if the deposit time limit is exceeded, the workflow management component can suspend the current process thread, complete the deposit process with the customer by issuing a provisional credit and notice to the depositing account, set a timeout indicator, and then resume the current process thread. The RFI (and each other middle tier bank) may include their own respective workflow management component to manage the processes and operations performed at those locations. If for any reason the process cannot be completed in real-time, the forward presentment, processing, and return presentment processes can be completed in an online manner.

The integrated process of FIGS. 7-10 provides several benefits. First, the integrated process can provide separate transmissions of the image associated with a check or payment item and the additional data associated with the check or item, thereby resulting in a reduction in the telecommunications cost and delay associated with existing batch and bulk data transmission processes. Both forward presentment and posting of checks and electronic payment items can be completed in a single day. Additionally, checks and electronic payment items processed online and in real-time can result in returned checks being eliminated from the process, thereby avoiding costs associated with managing and processing those items.

FIG. 7 is a flowchart illustrating an example method 700 for performing real-time and/or online straight-through check or electronic payment item processing, including forward presentment and returns presentment in an integrated processing system from the perspective of a BOFD associated with the depositor of the check or electronic payment item. For clarity of presentation, the description of method 700 that follows references environment 100 illustrated in FIG. 1. However, it will be understood that method 700 may be performed, for example, by any other suitable system, environment, or combination of systems and environments, as appropriate.

At 705, a check or payment item is received at an incoming system of a the BOFD. As previously described, the incoming system of the BOFD may include a teller workstation, a merchant-based capture system, a consumer-based capture application, or an ATM, among others. At 707, one or more deposit processing parameters are determined. The deposit processing parameters may be used to determine the type of processing to be performed on the deposit. An example set of deposit processing parameters may include a real-time parameter, a deposit time limit parameter, and a notification-only parameter. The real-time parameter may determine whether or not the deposit process is to be performed and completed in a real-time manner (i.e., while the customer interfaces or interacts with the BOFD through the incoming system), or whether the deposit is to be processed in an online manner (i.e., through the middle tier system, but not completed during the customer's interactions with the incoming system). The deposit time limit parameter, or time out value, can determine the amount of time to be allowed for deposit processing before a time out process or event occurs. The time limit parameter is meant to ensure that a customer or depositor interacting with the incoming system is not caused to wait longer than a maximum amount of time based upon an attempt to provide a fully real-time forward presentment and return presentment process. The notification-only parameter may determine whether the deposit processes are meant to be for notification purposes only (i.e., without settlements being performed). For example, a depositor may wish to determine if the checks and other electronic payment items to be deposited are valid and accepted by their respective RFI(s) before initiating an official deposit. By performing a notification-only process, the validity of a check or electronic payment item may be determined prior to the actual deposit, thereby avoiding potential returned check or electronic payment item issues and costs. The notification-only deposit process may be similar or analogous to the processes illustrated herein, but different in that no settlement or other legally-binding transactions are performed. In notification-only instances, the incoming system and the depositor may be notified of potential issues from the checks or payment items, allowing those items to be removed from the deposit stream. Additional deposit processing parameters may be determined as appropriate.

In some instances, one or more of the deposit processing parameters may be dynamically determined by the incoming system or the middle tier of the BOFD. In one instance, the type of incoming system through which the check or electronic payment item is received may determine at least one of the parameters. For example, if the payment item is received at a teller workstation, the time out parameter may be defined to be a default value associated with an average teller transaction and deposit. If the real-time process takes longer than that default time, the BOFD can present a receipt for the transaction as completed by the BOFD at that point and perform the additional processes after the customer (or depositor) has ended their interaction with the incoming system. The particular customer (or depositor) may also be used to determine one or more of the payment item processing parameters, such as through a manual selection or a predefined account setting. Further, the type of deposit transaction may be used to dynamically determine one or more of the processing parameters. For example, if the number of payment items included in a deposit exceeds a predetermined threshold or maximum for real-time processing, the initial deposit system may not desire real-time processing and instead designate that the deposit be processed online only. Other methods of determining the parameters can be used as appropriate.

At 710, and upon receiving the check or payment item, an image file containing scanned images or snapshots of the received check or payment item is generated. The image file may include an image of the front and back of the check or payment item, a capture of the MICR line data, and any other check or payment item-related information. At 715, the image file of the payment item and the set of processing parameters are transmitted from the incoming system of the BOFD to the BOFD's middle tier. The length and type of transmission at 715 depends on the incoming system at which the check or payment item was received, as well as the location of the BOFD's middle tier system. The transmission of the image file and processing parameters to the BOFD may be a message including the image file and the processing parameters to a back-end system located at the BOFD, or to a system connected to the middle tier system by a VPN or internal network within the BOFD's information technology systems. If, alternatively, the incoming system where the check or payment item was received is remote from the BOFD (i.e., at a merchant capture device or a consumer capture device), then the image file and processing parameters may be packaged and sent via the Internet, a private connection, or other suitable type of network to the BOFD's middle tier system. In general, communications of the image file may be encrypted to maintain security of the check or payment item information during transmission.

At 720, the middle tier of the BOFD determines an expected RFI for the check or payment item based on the image file. Additionally, information received or entered at the incoming system of the BOFD may also be used to determine the expected RFI of the image file. The image file may be processed using OCR, and the initial scan of the MICR line may be decoded to determine the likely or expected RFI of the image file and associated payment item. Information captured at the incoming system, such as manually keyed entries, may be used to determine the expected RFI of the image file and the payment item.

At 725, the image file and the determined deposit processing parameters are transmitted to the RFI's (destination bank's) middle tier system. The image file (and parameters) may be sent prior to any additional processing and validation of the image file (other than determining the expected RFI), thereby avoiding potential communication delays that may occur later in the process after additional check validation processing at the BOFD and its middle tier are complete. The image file can be effectively (and optionally) streamed to the expected RFI while or prior to performing the local BOFD processing and validation processes. The operations of 725 may be optional in implementations of method 700. Alternatively, the BOFD could elect to send the image file and transit item as a single transaction/communication as described at 755.

At 730, the middle tier of the BOFD performs the in-depth processing operations associated with check processing and validation. These operations include any number of steps and validations, including, for example, MICR codeline verification, image quality analysis, amount keying, fraud detection, and suspect review, among others. Generally, the middle tier analysis confirms the information received at the incoming system, as well as the image file quality, and uses that information to finalize a transaction associated with the received check or electronic payment item. In most instances, the middle tier operations require little to no human interaction to perform the required processes and create the associated transactions. In some cases, however, issues may arise that require manual intervention to complete the process. At 735, a determination is made as to whether issues arose as to the processing or validation of the received check or electronic payment item. If no issues arose, method 700 continues at 745. If, however, issues arose during the validation and processing operations, method 700 continues at 740, where manual entries, corrections, and reviews of the transaction, image file, and associated data are performed. These manual steps may be performed by individuals or representatives local to the middle tier system in some instance, or by remotely located employees or contractors in other instances. Method 700 can then continue at 745. Unlike the processes described in FIG. 2, no final or memo posting is performed at the BOFD until the RFI performs its portion of the integrated forward presentment processing and returns presentment processing operations illustrated in FIG. 8. Only after information as to how the payment item was processed by the RFI is received at the BOFD will posting and completion of the deposit transaction occur (unless the deposit processing parameters or events of the processing indicate otherwise

At 745, a confirmation or error notification from the RFI's middle tier system concerning the image file sent at 725 is received. A confirmation may be received if the RFI determines that the sent image file is associated with the RFI. An error notification may be received if the RFI determines that the image file (and payment item) is not associated with the RFI, if the image file is unable to be read, or if any other issues are identified with the image file. In some implementations, the confirmation notification may be optional, with the operations of method 700 performing under an assumption that the image file is associated with the expected RFI unless otherwise notified through an error notification.

At 750, a transit item associated with the received check or payment item is generated. Transit items may be used to send transaction information to the receiving financial institution (RFI) associated with the received check or electronic payment item. In some instances, these transit items may be called “on others items,” indicating that the check or payment item is drawn on another financial institution. In some instances, the check or payment item received at 705 may be provided by the BOFD's customer, as well as drawn on the BOFD itself (an “on-us item”). In these instances, all processing may be performed in-house at the BOFD, with the BOFD's host system performing the necessary transactions to accurately reflect the account changes related to the transaction. As illustrated in FIG. 7, however, the received check or payment item is not drawn on the BOFD but is “in network” and therefore is sent as a transit item to the RFI through the middle tier at 755. During the in-depth processing steps of 730, the middle tier of the BOFD determines the actual RFI of the check or payment item, including a comparison as to whether the expected RFI determined at 720 is the same as the actual RFI. In most cases the two will match, and the previously-transmitted image file will already have arrived at the actual RFI. In those cases, the transit item may not include the image file, and may instead include a unique identifier that can be used by the actual RFI to match the previously-received image file with the transit item (sent at 725). If, however, the actual RFI and the expected RFI do not match or an error notification was received from the expected RFI, the corresponding image file is resent to the actual RFI with, or included in, the transit item. Additionally, the one or more parameters determined at 707 may be sent with or included in the transit item, such that the actual RFI can use the information during its processing of the check or electronic payment item.

FIG. 8 is a flowchart illustrating an example method 800 for performing real-time and/or online straight-through check or electronic payment item processing, including forward presentment and returns presentment in an integrated processing system from the perspective of a receiving bank (payor/endpoint), or RFI, associated with the maker of the check or payment item, in accordance with the system of FIG. 1. As illustrated, FIG. 8 corresponds and complements the operations illustrated in FIG. 7 and method 700, although alternative implementations may correspond to different processes.

At 805, the RFI receives an image file, a set of payment item processing parameters, and, in some cases, metadata or other information associated with the image file. The RFI receives this information from a middle tier system associated with a BOFD. The image file is generally received at the RFI's middle tier system via a network or other communication means from the BOFD's middle tier through a secured communications channel. The image file may include or be associated with a unique identifier that can be used to later connect or associate additional transit information and transaction data with the received image file. In general, the image file may include an image of the front and/or back of a check or other electronic payment item, as well as an image or other information associated with the MICR line of the payment item. In some instances, the received image file can be stored in a local image repository until additional information is received from the BOFD. Additionally, any payment item processing parameters received with the image file can be stored at the RFI's middle tier for use with further processing.

At 810, the RFI determines whether the received image file is associated with the RFI. If the image file is not associated with the RFI, method 800 moves through 815 to 820 where a rejection notification is sent back to the BOFD in response. Alternatively, the RFI can delete and ignore the image file and related data based upon operational standards between the RFI and the BOFD. If, however, the image file is confirmed to be associated with the RFI, method 800 continues at 823, where a confirmation is optionally sent to the BOFD based upon operational standards between the RFI and the BOFD. At 825, a transit item associated with the received image file is received from the BOFD. The time between receiving the image file in 810 and receiving the transit item in 825 may vary in different situations (e.g., when additional processing and validation is required at the BOFD). In order to complete a real-time process, however, the transit item should arrive within seconds (or less) so that the transaction can be completed while the depositor interacts with the BOFD's incoming system (i.e., in real-time). The processing parameters received at 805 (and/or with the transit item at 825) may be used to determine the amount of time the RFI has for processing before the real-time process will time out at the BOFD. For purposes of the illustrated method 800, a consideration of whether the time out parameter is exceeded is not included. In addition to determining whether the image file is associated with the RFI, the RFI can begin check or payment item processing operations on the image file at 810, or any other time prior to receiving the transit item associated with the image file from the BOFD at 825. By doing so, concurrent processing of the check or electronic payment item can be performed at both the BOFD and the RFI to generally decrease the overall, end-to-end processing time.

Returning to 825, the received transit item may be associated with a previously received image file. The association of the transit item with the received image file may be performed based on identical, matching, or related unique identifiers associated with both the received image file and the received transit item. For example, the RFI's middle tier may perform comparisons of the received transit item's identifier with those of a plurality of stored image files to properly associate the two files. Once the received transit item is associated with the correct image file (including an image file included with, attached to, or embedded in the transit item), the RFI's middle tier performs an in-depth processing of the transit item and image file at 830. The in-depth processing operations of 830 may include various processing and validation operations. In some instances, the processing and validation operations may be identical for both the BOFD's middle tier and the RFI's middle tier. In other instances, the validation and processing operations of the RFI may include additional or fewer operations than the similar process at the BOFD, as well as performing the various operations in a different order than the BOFD. In some instances, the BOFD's middle tier may supply the RFI's middle tier with information regarding the validation and processing operations and results performed at the BOFD. In some instances, and based on the received information on the BOFD middle tier's analysis, the RFI may accept certain validation or processing operations as completed or unnecessary at the RFI's middle tier (e.g., the image quality analysis operations). In other instances, the RFI's middle tier may perform the standard validation and processing operations regardless of the results at the BOFD.

At 835, the RFI's middle tier system determines whether any issues arose during the processing of the received transit item and image file. If no issues arose, method 800 continues at 850, where the RFI middle tier submits the transaction information to the RFI's host system, where the associated customer's (or maker of the check or electronic payment item) account information is updated using a final post. Alternatively, if issues were encountered during processing and validation, method 800 continues at 840, where the RFI's middle tier system can perform a manual entry and correction process for perfecting or further analyzing the payment item or items associated with the issue. The manual review, corrections, and/or entries may be performed by users associated with the RFI's middle tier, as well as by one or more automated correction processes. At 845, based upon the changes performed in 840, the RFI can re-confirm whether or not the check or electronic payment item is actually associated with the RFI (i.e., if the image file and the transit data are both received at 825). If the payment item is associated to the RFI, method 800 continues at 847, where an appropriate adjustments process may be performed, along with a “Rejected” notification being sent to the BOFD. If, however, the additional analysis of the item confirms that the payment item is associated with the RFI, then method 800 continues at 850, where the RFI's host system can perform a final post of the item. The final post of the item determines if the check or payment item is “Paid”, “Accepted”, or “Returned”. For “Paid” items, the final post action can debit the account of the payment item's maker, while an “Accepted” item may perform a memo post (or other temporary action) at the RFI until the item is confirmed and changed to “Paid” at a later time. If the item is determined to be “Returned”, such as for insufficient funds or another reason, the final post may represent the determination by the RFI that the payment item cannot be paid as requested by the BOFD. The final post action of the RFI may include performing final settlements and modifications of various accounts at the RFI, including customer, intra-bank and inter-bank accounts. Alternatively, if the RFI does not have real-time posting capabilities, the RFI can choose to memo post the transaction while still sending an “Accepted” posting decision notification to the BOFD.

At 855, the RFI can transmit a posting results notification to the BOFD's middle tier system identifying the payment item (or items) as “Paid”, “Accepted”, or “Returned”. This posting results notification is similar to the rejection notification defined in step 820. As previously described, the RFI determines the appropriate classification of the payment item based on information in the account of the maker of the payment item at the RFI. That information can then be returned to the BOFD to allow the BOFD to determine how to proceed in its final post and settlement processes. In total, the posting results notification may include the classification of the payment item at the RFI (i.e., “Paid”, “Accepted”, “Rejected”, or “Returned”). If the item is “Rejected” or “Returned”, a reason for the classification may also be included.

FIG. 9 is a flowchart illustrating a continuation of the example methods 700 and 800 of FIGS. 7 and 8, respectively, for performing real-time and/or online straight-through check or electronic payment item processing, including forward presentment and returns presentment in an integrated system from the perspective of the BOFD associated with the depositor of the check or payment item. Specifically, FIG. 9 can occur after the posting results transmitted at 855 of FIG. 8 are received at the BOFD from the RFI through the middle tiers.

At 905, the posting results notification is received. The posting results notification may be received as a message sent from the RFI to the BOFD's middle tier, and may be in any suitable format. The posting results notification can be parsed and interpreted by the BOFD's middle tier so that the appropriate action associated with the payment item can be performed at the BOFD to complete the real-time process. At 910, the BOFD determines whether the payment item was “Paid” at the RFI. If the item was “Paid”, method 900 can continue at 915, where the BOFD may perform a final posting process to provide the funds to the depositor's account as appropriate, with the depositor possibly provided immediate availability to the funds. The information on the availability of the funds can be sent to the incoming system of the BOFD with notification provided to the depositor via an interface device associated with the incoming system and/or a receipt. Any final settlement entries can be completed with reporting/audit information associated with the transaction being archived, including the image used for the payment item and at least a subset of the information and data associated with and derived from the payment item. This “Paid” process described above may vary per implementation based upon the operating standards of the BOFD for “Paid” checks or electronic payment transactions. If the item is not “Paid”, method 900 continues at 920.

At 920, a determination is made as to whether the payment item is “Accepted”. If the item is “Accepted”, method 900 continues at 925, where a final posting process associated with an “Accepted” item is performed. The final posting process for an “Accepted” item may include providing the depositor with deferred availability to the funds as designated by the BOFD and a corresponding notice sent or provided to the incoming system and the depositor. Any final settlement entries can be completed with reporting/audit information associated with the transaction being archived, including the image used for the payment item and at least a subset of the information and data associated with and derived from the payment item. This “Accepted” process described above may vary per implementation based upon the operating standards of the BOFD for “Accepted” checks or electronic payment items. If the item is not “Accepted”, method 900 continues at 930.

At 930, a determination is made as to whether the item is “Rejected”. If the item was “Rejected”, method 900 continues at 935 where the final posting process for a “Rejected” item is performed. The final posting process for a “Rejected” item may include providing the depositor with deferred availability to the funds as designated by the BOFD and a corresponding notice sent or provided to the incoming system and the depositor. Any final settlement entries can be completed with reporting/audit information associated with the transaction being archived, including the image used for the payment item and at least a subset of the information and data associated with and derived from the payment item. The “Rejected” item can then be addressed and finalized between the BOFD and RFI using standard intra-bank and inter-bank adjustment processes. The “Rejected” process described may vary per implementation based upon the operating standards of the BOFD and RFI for “Rejected” checks or electronic payment items.

If, however, the item was not “Rejected”, then method 900 continues at 940 where a final posting process for “Returned” items is performed. The final posting process for a “Returned” item may include reversing any funds made available based on the deposited item and providing the “Returned” information to the depositor at the interface of the incoming system of the BOFD. The depositor can have immediate knowledge of the “Returned” item and allowed to, where appropriate, immediately take action with the maker of the payment. The immediate ability to identify a “Returned” item is of special importance when used with a merchant-capture device as the incoming system, as the merchant may be able to refuse a sale based on the “Returned” item or request alternative means for payment. Additionally, any final settlement entries associated with the item can be completed, including modifying any inter-bank accounts that may have been initially credited or debited for the attempted deposit. The “Returned” process described may vary per implementation based upon the operating standards of the BOFD.

FIG. 10 is an example signaling and flow diagram of process 1000 illustrating operations associated with performing real-time and/or online straight-through processing including forward presentment and returns presentment processes for a check or other electronic payment item, including the operations of a teller system, a middle tier architecture and host system associated with a BOFD, and a middle tier architecture and host system associated with a RFI in accordance with the system of FIG. 1. Specifically, the system of FIG. 10 illustrates operations across a customer, a teller (or teller-equivalent or other capture device), a middle tier system and a host system associated with a BOFD (middle tier A and host system A), and a middle tier system and a host system associated with an RFI (middle tier B and host system B). Although certain operations are illustrated as associated with or performed by a particular element, any suitable combination of illustrated or non-illustrated elements and operations or processes may be used to perform the steps and operations described. FIG. 10 illustrates one process associated with example implementations of methods 700, 800, and 900.

At 1005, a customer/depositor provides a check or payment item to an incoming system (or initial deposit point) of a BOFD. For purposes of FIG. 10, the check or payment item is provided or deposited to a teller at a branch office at the BOFD. At 1010, the payment item is scanned or otherwise captured to generate an image file of the payment item, and the scanned image file is sent to the middle tier A associated with the teller and BOFD. Simultaneously (or concurrently) with the image file being sent to the middle tier A, the teller can perform a set of initial processing operations on the received payment item (at box 1020). In some instances this may include the teller adding customer-specific information along with the payment item, such as a customer account number, a driver's license number, and other related operations.

At box 1015, middle tier A received the scanned image file associated with the payment item. At box 1025, middle tier A determines an expected destination endpoint/RFI for the check or payment item based on the scanned image file (or alternatively, any information included or transmitted with the image file, including data entered by the teller). Once the expected RFI is determined, at box 1030 middle tier A forwards the image file (containing at least the image file and a unique identifier for associating additional, related information with the payment item) to middle tier B of the second system, where at box 1035 middle tier B receives the image file. Middle tier B stores the scanned image file and associated unique identifier in local (or remote) storage for later use and association with finalized transit items at box 1050. By sending the image file prior to the processing steps at the middle tier A, the system allows for immediate presentment at middle tier B once the transit item is received without any communication delays from the larger bandwidth intensive transmission of the image file. Additionally, the transmission of the image file from one middle tier to another generally constitutes a majority of the data exchanged between financial institutions. By performing this time- and data-intensive task early in the operations, and specifically while various other operations are being performed at the BOFD's middle tier A, the time required to clear and finalize transactions throughout the system is greatly reduced. The transmission of image files and other data between the respective middle tiers may be performed over any appropriate communication protocols and/or channels, including a VPN between the systems, a dedicated network connection, or encrypted communication over the Internet, among others.

At box 1040, the first portion of the teller transaction is completed, with any additional intake or initial processing data or information associated with the payment item being completed. The scanned image file and the results of the teller processing are provided to middle tier A of the BOFD, where at box 1045 the middle tier A performs the various middle tier validations and processing operations on the payment item and image file, including an image quality analysis, a MICR codeline confirmation, and other related processes. Once the middle tier processing and validation of the payment item is complete, at box 1060 the middle tier A sends the transit data associated with the payment item to middle tier B of the actual RFI (confirmed during the processing operations at box 1045).

At box 1065, middle tier B receives the data associated with the payment item and the received scanned image from middle tier A. At box 1070, middle tier B confirms that the received payment item is associated with host B and the RFI. If not, an error message can be returned to the BOFD through middle tier A. If the payment item is associated with the RFI, process 1000 continues at box 1075, where middle tier B performs its own validation and processing of the payment item, its image file, and the associated data and information. A determination as to whether the account associated with the maker of the payment item contains sufficient funds, as well as any other appropriate analyses, can be performed at box 1075, including a determination as to whether the payment item is to be “Paid”, “Accepted”, “Rejected”, or “Returned”. At box 1080, middle tier B completes its processing operations and performs its final post processes associated with the payment item. At box 1085, the middle tier B and the host B perform the final posting of the payment item, including debiting the accounts associated with the maker of the payment item (where appropriate), the maker being a customer or account holder at the RFI. At 1090, middle tier B, after receiving confirmation of the final posting from the host B, returns a set of posting results through the middle tier to the BOFD providing the BOFD information on how the payment item was processed at the RFI.

At box 1095, middle tier A receives the posting results notification from middle tier B and parses them for further processing. At box 1100, a determination is made at middle tier A as to whether the payment item was “Paid” at the RFI. If the item was “Paid”, host A performs its “Paid” process at box 1105 with the funds being made immediately available to the customer. At box 1110, the teller performs the processes associated with the payment item's “Paid” status, and at box 1115, the customer receives a receipt reflected the payment item's amount as available within the customer's account. If the item was not “Paid”, process 1000 continues at box 1130, where a determination is made as to whether the payment item was considered “Accepted” by the RFI. If so, host A performs its “Accepted” process at box 1135 by crediting the customer's account with the deposit amount with deferred availability. The teller performs an “Accepted” process at box 1140, and the customer receives a receipt indicating that the deposit is complete and of the funds availability. If the item was not “Accepted”, process 1000 continues at box 1150, where a determination is made as to whether the item was “Rejected”. If the item was “Rejected”, then at box 1155 the host A performs a “Rejected” process, which may include providing a temporary or deferred availability posting to the depositor's account as designated by the BOFD's operating procedures. At box 1160, the teller can perform an appropriate “Rejected” process, with the customer receiving a receipt reflecting the rejected decision and the temporary or deferred availability of funds. If the item was not “Rejected”, process 1000 continues at box 1170, where the item is identified as returned at middle tier A. The appropriate return process is performed at host A (box 1175). The return process at box 1175 can include reversing of any credited accounts, and causing a notification to be generated. At box 1180 the teller performs the corresponding return process, which may include notifying the customer/depositor of the issues. At box 1185, the customer can receive a receipt reflecting the returned decision, including a listing and identification of the returned item.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

A number of embodiments of the present disclosure have been described. Nevertheless, it will be understood that various modifications may be made without departing from the spirit and scope of the present disclosure. For example, the processes described herein may also be applicable to any electronic payment in which real-time and/or online straight-through processing is accomplished via online communication between the respective middle-tiers of the BOFD and the receiving financial institution. In another example, the described processes may be performed as a notification only process. In notification only processes, a check or electronic payment instrument may be identified as valid or not prior to, or without, attempting settlement of that item. In those instances, the processes may remain similar to those as described above, but without the posting and settlement activities of the BOFD and the RFI. One advantage of such a process would be to identify valid checks and payment instruments without submitting those payment items to the settlement systems, wherein additional costs associated with a returns process may add fees and service charges to the customer accounts at both the BOFD and the RFI. Accordingly, other embodiments are within the scope of the following claims.

What is claimed is:

1. A method comprising:
receiving a payment item for processing at a first financial institution, where the payment item is received from a customer via an incoming system associated with the first financial institution, the receipt of the payment item initiating a customer transaction performed at the incoming system;
during the customer transaction:
generating an image file associated with the received payment item;
processing the received payment item and generated image file for posting a transaction to a customer account at the first financial institution, where processing the received payment item includes generating a transit item associated with the received payment item;
transmitting the generated image file and the transit item to a second financial institution associated with the payment item, the second financial institution operable to post a transaction associated with the payment item, the transmitted image file, and the transit item; and
prior to completion of the customer transaction:
receiving, at the first financial institution, a notification from the second financial institution identifying the posting results of the second financial institution's transaction associated with the payment item, the transmitted image file, and the transit item; and
performing a posting at the first financial institution based, at least in part, on the received posting results notification.

2. The method of claim 1, wherein the payment item comprises a check.

3. The method of claim 2, wherein the incoming system comprises a teller capture device, a merchant capture device, an automated teller machine (ATM), or a consumer capture device.

4. The method of claim 1, wherein generating the image file associated with the received payment item includes capturing digital images of one or more of the following: a front of the payment item, a back of the payment item, and a Magnetic Ink Character Recognition (MICR) line from the payment item.

5. The method of claim 1, wherein processing the received payment item and generated image file for posting to the customer account at the first financial institution includes performing one or more of the following: MICR codeline verification, image quality analysis, manual amount keying, fraud detection, and suspect review.

6. The method of claim 1, wherein the posting results from the second financial institution include one of: Paid, Accepted, Rejected or Returned.

7. The method of claim 6, wherein the posting at the first financial institution based on the received posting results notification being Paid includes an immediate credit to an account associated with the customer.

8. The method of claim 6, wherein the posting at the first financial institution based on the received posting results notification being Accepted includes providing a deferred credit to an account associated with the customer.

9. The method of claim 6, wherein the posting at the first financial institution based on the received posting results notification being Rejected includes providing a deferred credit to an account associated with the customer.

10. The method of claim 6, wherein the posting at the first financial institution based on the received posting results notification being Returned includes providing no credit to the account associated with the customer and providing a notice of the return to the customer.

11. The method of claim 6, further comprising, after performing the posting at the first financial institution based, at least in part, on the received posting results notification, generating a receipt for the customer reflecting the posting at the first financial institution and completing the customer transaction at the incoming system.

12. The method of claim 1, wherein:
the image file is transmitted to the second financial institution at a first instance immediately upon the image file's generation; and
the transit file is transmitted to the second financial institution after the image file is transmitted and after processing the received payment item at the incoming system.

13. A computer storage medium encoded with a computer program, the program comprising instructions that when executed by data processing apparatus cause the data processing apparatus to perform operations comprising:
receiving a payment item for processing at a first financial institution, where the payment item is received from a customer via an incoming system associated with the first financial institution, the receipt of the payment item initiating a customer transaction performed at the incoming system;
during the customer transaction:
generating an image file associated with the received payment item;
processing the received payment item and generated image file for posting a transaction to a customer account at the first financial institution, where processing the received payment item includes generating a transit item associated with the received payment item;
transmitting the generated image file and the transit item to a second financial institution associated with the payment item, the second financial institution operable to post a transaction associated with the payment item, the transmitted image file, and the transit item; and
prior to completion of the customer transaction:
receiving a notification from the second financial institution identifying the posting results of the second financial institution's transaction associated with the payment item, the transmitted image file, and the transit item; and
performing a posting at the first financial institution based, at least in part, on the received posting results notification.

14. The computer storage medium of claim 13, wherein the payment item comprises a check.

15. The computer storage medium of claim 13, wherein the incoming system comprises a teller capture device, a merchant capture device, an automated teller machine (ATM), or a consumer capture device.

16. The computer storage medium of claim 13, wherein generating the image file associated with the received payment item includes capturing digital images of one or more of the following: a front of the payment item, a back of the payment item, and a Magnetic Ink Character Recognition (MICR) line from the payment item.

17. The computer storage medium of claim 13, wherein processing the received payment item and generated image file for posting to the customer account at the first financial institution includes performing one or more of the following: MICR codeline verification, image quality analysis, manual amount keying, fraud detection, and suspect review.

18. The computer storage medium of claim 13, wherein the posting results from the second financial institution include one of: Paid, Accepted, Rejected or Returned.

19. The computer storage medium of claim 18, wherein the posting at the first financial institution based on the received posting results notification being Paid includes an immediate credit to an account associated with the customer.

20. The computer storage medium of claim 18, wherein the posting at the first financial institution based on the received posting results notification being Accepted includes providing a deferred credit to an account associated with the customer.

21. The computer storage medium of claim 18, wherein the posting at the first financial institution based on the received posting results notification being Rejected includes providing a deferred credit to an account associated with the customer.

22. The computer storage medium of claim 18, wherein the posting at the first financial institution based on the received posting results notification being Returned includes providing no credit to the account associated with the customer and providing a notice of the return to the customer.

23. The computer storage medium of claim 18, the operations further comprising, after performing the posting at the first financial institution based, at least in part, on the received posting results notification, generating a receipt for the customer reflecting the posting at the first financial institution and completing the customer transaction at the incoming system.

24. The computer storage medium of claim 13, wherein:
the image file is transmitted to the second financial institution at a first instance immediately upon the image file's generation; and
the transit file is transmitted to the second financial institution after the image file is transmitted and after processing the received payment item at the incoming system.

25. A system comprising:
an incoming system associated with a first financial institution adapted to:
receive a payment item for processing from a customer associated with the first financial institution, where receiving the payment item initiates a customer deposit transaction;
generate an image file associated with the received payment item; and
transmit the generated image file to at least one middle tier server associated with the first financial institution;
one or more middle tier servers in a middle tier system associated with the first financial institution adapted to:
identify a second financial institution associated with the received payment item;
process the received payment item and generated image file in preparation for posting a first transaction associated with the received payment item to a first customer account at the first financial institution, where processing the received payment item includes generating a transit item associated with the received payment item;
transmit the image file and the transit item to a middle tier system associated with the second financial institution for posting and processing of the payment item; and
one or more middle tier servers in a middle tier system associated with the second financial institution adapted to, during the customer transaction:
receive the transmitted image file and the transit item from the middle tier system of the first financial institution;
process the received transit item and image file in a posting process for a second customer account at the second financial institution associated with the payment item;
transmit a posting result notification to the middle tier system associated with the first financial institution; and
the one or more middle tier servers in the middle tier system associated with the first financial institution further adapted to:
receive the posting result notification from the second financial institution; and
perform a posting to the at the first financial based at least in part on the received posting result notification.

26. The system of claim 25, wherein the incoming system associated with the first financial institution includes a teller at a local branch of the first financial institution.

27. The system of claim 25, wherein the middle tier system of the first financial institution is adapted to communicate, via a network, with the middle tier system of the second financial institution.
